(19) United States
(12) Patent Application Publication
(10) Pub. No.: US 2016/0044909 A1
(43) Pub. Date: Feb. 18, 2016

(54) Dispenser for Dispensing Foam such as Foam Herbicides

(71) Applicant: John Karl Lampe, St. Paul, MN (US)

(72) Inventor: John Karl Lampe, St. Paul, MN (US)

(21) Appl. No.: 14/824,941

(22) Filed: Aug. 12, 2015

Related U.S. Application Data
(60) Provisional application No. 62/061,487, filed on Oct. 8, 2014.
(60) Provisional application No. 62/038,807, filed on Aug. 18, 2014.

(51) Int. Cl. A01M 21/04; B05B 7/00; B05B 7/04

(52) U.S. Cl. CPC A01M 21/043; B05B 7/0416; B05B 7/0025

(57) ABSTRACT

This invention relates to a device for dispensing foam onto plants and other objects. According to one example, the dispenser for dispensing foam comprises: a supply line in which a foamable solution flows under pressure and which comprises a gas inlet, a wand, a mixing chamber, and a nozzle, wherein the gas inlet introduces a gas into the foamable solution, the mixing chamber helps process the foamable solution into a foam, and the nozzle ejects the foam. In a variation, the mixing chamber can be located distally on the wand. In another example, the dispenser for dispensing foam comprises: a wand fluidly connected to a nozzle for ejecting a foam and a wiper attached to the wand, the wiper being for temporarily retaining ejected foam and making the foam available for wiping the foam onto a target surface.

### BACKGROUND OF THE INVENTION

The prior art contains devices that dispense foams. Foams are useful in diverse contexts ranging from firefighting to dispensing cleaners.

Foams are not commonly used for the application of fluid chemicals such as herbicides to plants. The usual method is to use spray equipment that turns fluid mixtures into a spray of drops. Drops are sprayed on various parts of the plant such as foliage and stems. Drops are also sprayed on cut surfaces such as cut stumps of woody species and brush.

Spraying drops of chemical mixtures on plants, however, can cause problems. Many of the drops of fluid may not reach the target plant. The spray pattern of a spray nozzle will not always match the target at a given moment of spraying, and some drops will pass by targeted foliage, stems, etc., and hit the ground, desirable plants, etc. In addition, drops, especially fine ones, may drift or otherwise move out of the spray pattern after being dispensed and move off-target.

If drops do reach the target, not all of them will evade plant defenses and enter the plant's internal system. Fine drops that reach the target can dry quickly, and the active ingredient in the dried spray on the leaf may not be absorbed as efficiently by the plant. Large drops may contact the target plant surfaces and bounce, roll, or drip off. Lastly, small and medium-sized drops may coalesce on surfaces into large ones and behave like large ones and not stay on the plant surface.

In addition, spray equipment, especially large agricultural spray equipment often uses high pressure—up to approximately 20 bar (290 psi). With increasing pressure, spray equipment—tanks, hoses, nozzles, etc., all must be more robust to handle the pressure. High pressure can pose hazards to people if components malfunction. Higher pressures also increase the chance for drift.

These and other problems with conventional spray equipment increases purchase and maintenance costs, heightens the risk of drift, spills, and hazards to people and the wider environment.

To overcome these shortcomings of spray systems, other dispensers have been developed. For example, some devices wipe liquid chemical mixtures onto plants. These are used mostly for wiping herbicides onto plants. Generally, a wiper is brought in direct contact with or close to a plant, and the herbicide mixture is transferred from the wiper surface to the plant.

Wiper systems typically use absorbent materials: sponge foam, rope, fabric sheets, canvas, or even carpet. The simplest are handheld wick systems where an herbicide solution is wicked from a bottle to a sponge applicator mounted in the bottle cap. The operator daubs the herbicide solution onto a plant surface.

More sophisticated systems can have spray booms encased or partially covered with canvas or be mounted inside rotating drums with absorbent material. The absorbent material is then sprayed on the inside, and the herbicide soaks through the material to the outer surface which acts as the wiping surface.

Herbicide application with wipers can have advantages over prior art spray systems: drift can be virtually eliminated. Another advantage with applying fluids such as herbicides with wipers is that lower pressure can be used. This mean that tanks, hoses, etc., need not be so heavily reinforced; equipment can be less prone to breakdown or premature wear. It can also mean that the wiping action can deliver the solution with less force to the target. This may reduce rebound or deflection off a leaf or other plant surface.

The prior art wiper devices, however, suffer from a number of shortcomings. It can be difficult to control the saturation of the wiping surface. If the wiping surface becomes over-saturated it can drip excessively. In fact, liquid herbicide can even pour from the wiping surface. If a saturated sponge of fabric material is tilted, liquid herbicide can sometimes pour from the lowest portion. On the other hand, if the wiping surface becomes too dry, insufficient herbicide will be transferred to the target weed. To control drippage but ensure adequate application, the operator must be very skilled at regulating how much liquid is directed to the wiping surface, how fast the wiping surface is wiped across the target plants, and the height of the wiping surface in relation to the target plant.

Another major shortcoming with prior art wiping systems is that the wiping surfaces of the devices can become clogged or plugged. After repeated saturation, the wiping surface can become can become crusty and stiff, especially if the carrier contains hard water or the herbicide has suspended solids. Plant debris, dirt and other foreign matter can further clog the wiping surface. Plant matter such as burs, stickers, thorns, leaves, and even broken branches and stems can become stuck on wiping surfaces. When the absorbent surfaces of prior art wipers come in contact with these “sticky” plant parts and with dust and dirt, absorbent surfaces can quickly become plugged. Unfortunately, dirt and organic matter may reduce performance of certain herbicides such as those containing glyphosate.

Cleaning can be very difficult with prior art wiping systems. Absorbent surfaces may require repeated flushing with wash water. This wash water has to be contained and prevented from contaminating surface waters, cultivated crops, or natural ecosystems.

Foams can offer advantages over liquid sprays and wiping systems. Foams can volatilize less readily than the fine or even medium sized drops from sprayers. This means foam application systems can offer the same advantage that wiping systems offer in reducing spray drift.

Foams also can cling tenaciously to surfaces such as plant foliage. In contrast larger drops dispensed from spray systems or wiping systems may not adhere well to plant surfaces. Moreover, foams can increase the amount of surface area covered by a given amount of herbicide.

Devices have been developed to dispense foams. Many of these devices, however, have shortcomings when it comes to applications to plants. Many fail to adequately mix a gas (typically air) with the liquid herbicide solution, and the dispensed fluid is just a foam solution in which the solution is mostly water and lacks bubble structure. Such foam solutions have low expansion ratios and drain rapidly.

In addition, many foam dispensers use relatively high pressures. High pressures can make it difficult to ensure most of the fluid is dispensed as foam. Instead, some of the fluid can be ejected as fine drops (which can drift) thereby minimizing the advantages of the foam. In addition, the use of higher pressures can necessitate more robust materials and material thicknesses for the dispenser making it more expensive and heavier. Finally, high pressures can make foam quality less consistent, especially with hand powered equipment that may cause pressure irregularities.

The purpose of the present invention is to overcome the limitations in the prior art dispensing system particularly as they relate to the application of fluid chemicals to plants.

### SUMMARY OF THE INVENTION

The present invention generally relates to a device for dispensing foam onto plants, soils, and other objects. The device can be especially useful for spraying and wiping foams containing agricultural chemicals onto weeds. Many other uses are also possible including ones not involving plants or plant care.

According to a first illustrative example of the invention, a dispenser for dispensing foam comprises: a supply line in which a foamable solution flows under pressure and which comprises a gas inlet, a wand, a mixing chamber, and a nozzle, wherein the gas inlet introduces a gas into the foamable solution, the mixing chamber helps process the foamable solution into a foam, and the nozzle ejects the foam.

According to variations of this first example, the gas can be introduced proximally to the mixing chamber in the supply line; the mixing chamber can be located distally on the wand; the mixing chamber can contain a mixing medium, or the supply line can further connect a hose proximate to the wand.

In addition, with this example, foam may be ejected from the nozzle with a pressure between 0.5 and 20.0 psi; with a pressure between 0.5 and 15.0 psi; with a pressure between 0.5 and 10.0 psi; or with a pressure between 0.5 and 5.0 psi.

According to a second illustrative example of the invention, a dispenser for dispensing foam comprises: a wand fluidly connected to a nozzle for ejecting a foam and a wiper attached to the wand, the wiper being for temporarily retaining ejected foam and making the foam available for wiping the foam onto a target surface.

According to variations of this second example, the wiper can have a primary wiping surface that is impervious; the wiper can comprise a flat piece; the wiper can have a primary wiping surface that has an area greater than 4 cm²; the wiper can be a cage; the wiper can be a cage, the cage being tubular with at least one open end; the wiper can be a cage, the cage being tubular with no open end; the wiper can be a cage, the cage being rotatable on a longitudinal axis; the wiper can be a cage, the cage being a mesh material; the wiper can be a spatula; the wiper can be an elongated member; the wiper can be an elongated member; the wiper can be an elongated member and the nozzle can eject foam along a substantial portion of the length of the elongated member; or the wiper can be an elongated member and further comprise a cage covering at least a portion of the elongated member.

In addition, with this second example, foam may be ejected from the nozzle with a pressure between 0.5 and 20.0 psi; with a pressure between 0.5 and 15.0 psi; with a pressure between 0.5 and 10.0 psi; or with a pressure between 0.5 and 5.0 psi.

According to a third illustrative example of the invention, a dispenser comprises: a pressurized dispenser for dispensing a foam comprising: a supply line for moving a foamable solution, fluidly connected to a removable cartridge containing a porous mixing medium for mixing the foamable solution into a foam.

According to variations of this third example, the mixing medium can be a wad of material; the cartridge can be a hollow tube with at least one screen enclosing at least one end of the tube; or the cartridge can be a hollow tube with a screen enclosing each end of the tube.

According to a fourth illustrative example of the invention, a dispenser for dispensing foam comprises: an elongated tube and a nozzle in the wall of the tube for ejecting foam from the tube.

According to variations of this fourth example, the nozzle can be in a discrete portion of the tube; the nozzle can be elongated; the tube can have a firm wall; the tube can be horizontally positionable during dispensing; the tube can be horizontally and fixedly positionable during dispensing; the nozzle can eject foam along a substantial portion of the length of the tube; the nozzle can eject foam along most of the length of the tube; the tube can comprise two longitudinal halves and wherein the nozzle can be located in one of those halves; the nozzle can have an orifice that varies in size or orifices that vary in size along the length of the tube in order to eject foam more evenly along the tube; the dispenser can be operated by hand; the dispenser can further comprise a wiper attached to the dispenser, and the nozzle can eject foam onto a surface of the wiper; the dispenser can further comprise a wiper attached to the dispenser, and the nozzle can eject foam onto a surface of the wiper and where the wiper can further comprise a cage; the dispenser can further comprise a wiper attached to the dispenser, and the nozzle can eject foam onto a surface of the wiper and where the wiper can further comprise a rotatable cage; or the wiper can comprise a cage tubular in shape that covers at least a portion of the tube.

In addition, with this example foam may be ejected from the foam ejection system with a pressure between 0.5 and 20.0 psi; with a pressure between 0.5 and 15.0 psi; with a pressure between 0.5 and 10.0 psi; or with a pressure between 0.5 and 5.0 psi.

According to a fifth illustrative example of the invention, a dispenser for dispensing foam comprises: a boom and a foam ejection system for ejecting foam from the boom.

According to variations of this fifth example, the foam can be ejected evenly along a substantial portion of the length of the boom; the foam can be ejected evenly across most of the length of the boom; the boom can have a wiper or series of wipers attached to it and on which ejected foam can be retained and making the foam available for wiping the foam onto a target surface; the wiper can extend along a substantial portion of the length of the boom; the wiper can be made of an impervious material; the wiper can be made of a pervious material; the wiper can be made of a flexible material; the boom can have a wiper attached to it and the wiper can comprise a cage and the foam can be ejected into the cage.

In addition, with this example the foam ejection system may eject foam with a pressure between 0.5 and 20.0 psi; with a pressure between 0.5 and 15.0 psi; with a pressure between 0.5 and 10.0 psi; or with a pressure between 0.5 and 5.0 psi.

According to a sixth illustrative aspect of the invention, a dispenser for dispensing foam comprises: an elongated nozzle for ejecting foam into an elongated cage, making the foam available for wiping onto a target surface.

According to variations of this sixth example, the cage can be tubular with at least one open distal end; the cage can be tubular with no open end; the cage can be rotatable on a longitudinal axis; or the cage can be a mesh material.

In addition, in this example foam may be ejected with a pressure between 0.5 and 20.0 psi; with a pressure between 0.5 and 15.0 psi; with a pressure between 0.5 and 10.0 psi; or with a pressure between 0.5 and 5.0 psi.

According to a seventh illustrative example of the invention, a pressurized dispenser for dispensing foam comprises a nozzle for ejecting the foam having at least two orifices wherein the orifices are spaced sufficiently far apart as to eject at least two distinct streams of foam.

According to variations of this example, the nozzle can comprise at least three orifices; and the at least 3 orifices can vary in size.

In addition, with this example the nozzle may eject foam with a pressure between 0.5 and 20.0 psi; with a pressure between 0.5 and 15.0 psi; with a pressure between 0.5 and 10.0 psi; or with a pressure between 0.5 and 5.0 psi.

This summary is not intended to describe each illustrated embodiment, object, advantage, or use of the present invention. The figures and descriptions that follow more particularly exemplify these embodiments.

### BRIEF DESCRIPTION OF THE DRAWINGS

Below are descriptions of the drawings according to various embodiments of the invention.

FIG. 1A is a side view of a pressurized tank dispenser foam dispenser with a cutaway view of the tank interior.

FIG. 1B is a perspective view of a wand being used to treat a target weed.

FIG. 1C is a side view of a dip tube.

FIG. 1D is an exploded view of a cross-section of a mixing chamber with a cartridge.

FIG. 1E is a cross section of a mixing chamber sectioned along line A in FIG. 1F.

FIG. 1F is a front view of a nozzle face.

FIG. 1G is a cross section of a mixing chamber with dispensed foam sectioned along line A in FIG. 1H.

FIG. 1H is a front view of the nozzle face with dispensed foam.

FIG. 2A is a side view of a wand with a paddle.

FIG. 3A is a side view of a wand with a wiper with a cage.

FIG. 3B is a side view of a wiper with a cage including a spurt of foam.

FIG. 3C is a side view of a wiper with a cage filled with foam.

FIG. 3D is a view of the distal end of the wiper with a cage filled with foam.

FIG. 3E is a perspective view of an operator using a dispenser on target weeds.

FIG. 3F is a side view showing three positions of a wiper being moved across target weeds.

FIG. 4A is a side view of a wand with a wiper with a small cage.

FIG. 4B is a side view of a wiper with a small cage including a spurt of foam.

FIG. 4C is a side view of a wiper with a small cage filled with foam.

FIG. 4D is a view of the distal end of the wiper with a small cage filled with foam.

FIG. 4E is a perspective view of wand and wiper being used to apply foam to a cut stump.

FIG. 4F is a perspective view of wand and wiper being used to apply foam to a target weed.

FIG. 4G is a side view of a wand and wiper having a cage that is being pressed against a surface such as that of a stump.

FIG. 5A is a view of a tubular wiper with a slot showing a longitudinal centerline A.

FIG. 5B is a view of a tubular wiper with a slot with dispensed foam and showing a cross-sectional line B.

FIG. 5C is a cross-section view of the distal end of the wiper with dispensed foam the cross-section being along line A of FIG. 5B and showing longitudinal centerline A represented by a point and line C representing a plane which bisects the tube in half in a longitudinal direction.

FIG. 6A is a view of a single member wiper.

FIG. 6B is a view of a single member wiper with dispensed foam.

FIG. 6C is a view of the distal end of a single member wiper with dispensed foam

FIG. 7A is a side view of a handheld dispenser with a wiper on an extension tube.

FIG. 8A is a front view of an ATV vehicle with a boom including a wiper.

FIG. 8B is a side view of a first wiper outlet assembly unit.

FIG. 8C is a front view of a wiper with multiple units for mounting on a boom.

FIG. 8D is a front view of a wiper with one unit represented with a dashed line.

FIG. 8E is a partial cutaway view of the mixing chamber from the wiping unit represented by a dashed line.

FIG. 8F is a side view showing three positions of a wiper unit which is part of a boom being moved across target weeds.

FIG. 8G is a front view of an ATV vehicle with a boom including a wiper comprising a mat.

FIG. 8H is a side view of a wiper comprising a mat.

FIG. 8J is a front view of an ATV vehicle with a boom including a wiper in the form of a cage.

FIG. 8K is a side view of a wiper in the form of a cage.

FIG. 9A is a side view showing a handle with foam outlet assembly shooting a streams of foam at target weeds.

FIG. 9B is a cross section of the mixing chamber and outlet assembly sectioned along line A in FIG. 9C.

FIG. 9C is a front view of the distal end of the foam outlet assembly.

FIG. 9D is a cross section of the mixing chamber and outlet assembly shooting foam sectioned along line A in FIG. 9C.

FIG. 9E is a cross section of the mixing chamber and outlet assembly shooting foam sectioned along line B in FIG. 9C.

FIG. 10A is a side view of a handheld dispenser with a foliar outlet assembly.

FIG. 11A is a view of a wiper with a series of holes.

FIG. 11B is a cross-section view of the distal end of the wiper, the cross-section being along line A of FIG. 11A.

FIG. 12A is a side view of a wiper with a tube and freely rotating cage.

FIG. 12B is a view of the distal end of a wiper with a tube and freely rotating cage.

FIG. 12C is a side view showing three positions of an outlet assembly being moved across target weeds.

FIG. 12D is a side view of a wiper with a cage made of mesh covering the wiper.

FIG. 13A is a side view of a wiper with a tube and a partial cage with the cage rotated in an up position.

FIG. 13B is a view of the distal end of a wiper with a tube and a partial cage with the cage rotated in an up position.

FIG. 13C is a side view of a wiper with a tube and a partial cage with the cage rotated in a down position.

FIG. 13D is a view of the distal end of the wiper with a tube and a partial cage with the cage rotated in an down position.

FIG. 14 is a top view of an t-shaped outlet assembly.

FIG. 15A is a view of a wand with a wiper comprising a cage in the form of a mesh bag.

FIG. 16A is a side view of an outlet assembly with a wiper comprising a cage made of tubular mesh with an open end.

FIG. 17A is a side view of a wand with wiper having a tube with a mesh covering.

### DETAILED DESCRIPTION INCLUDING A BEST MODE

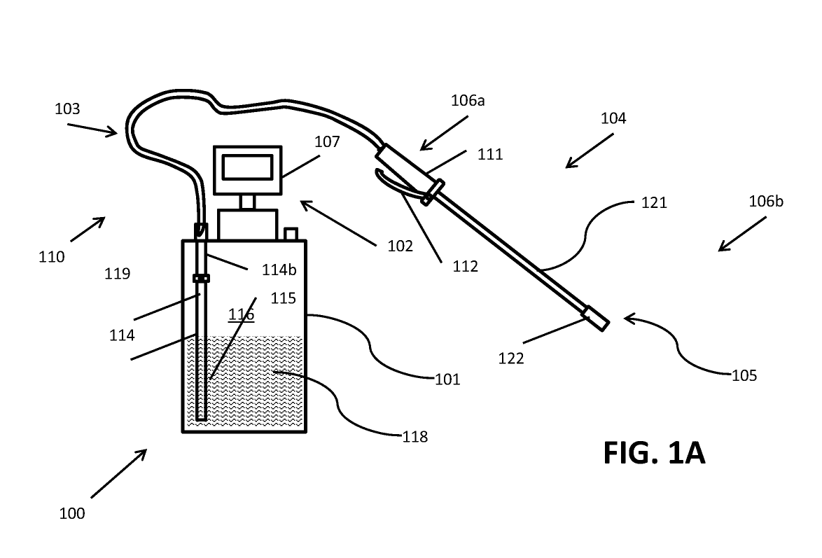

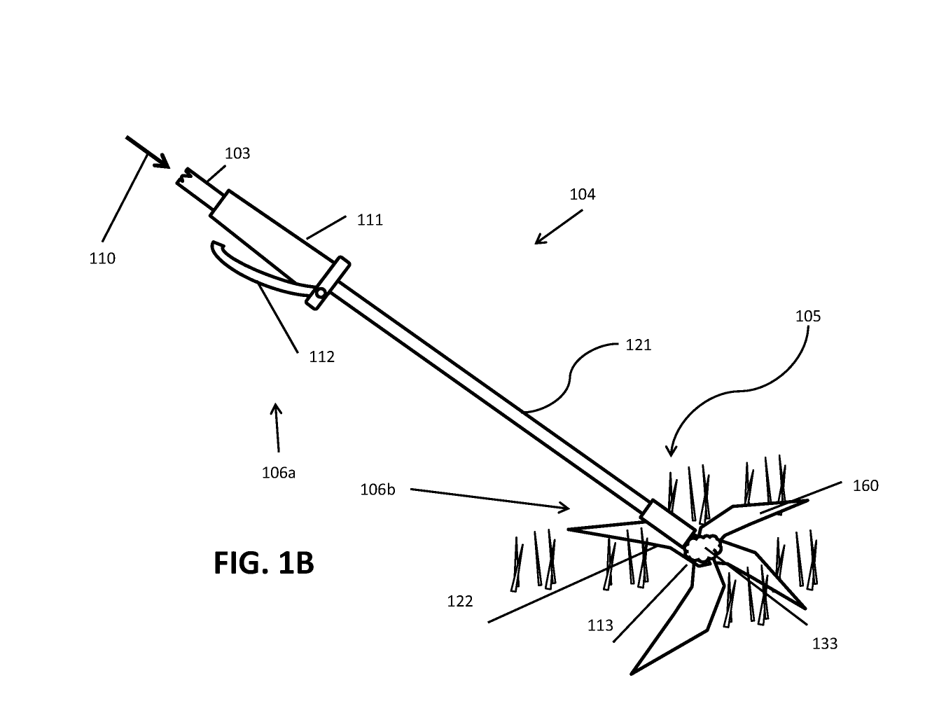

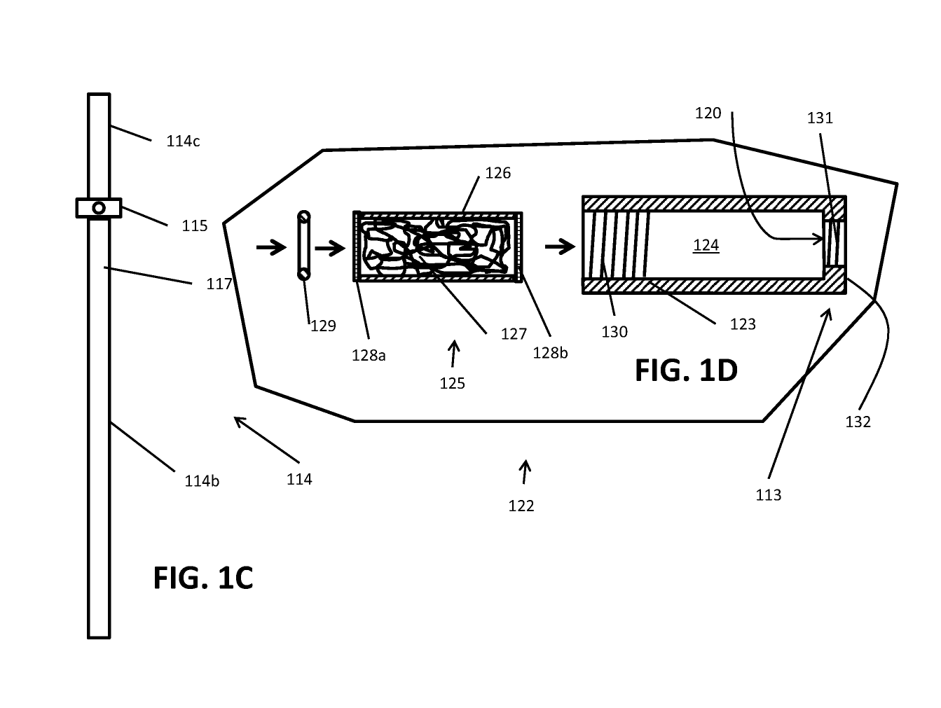

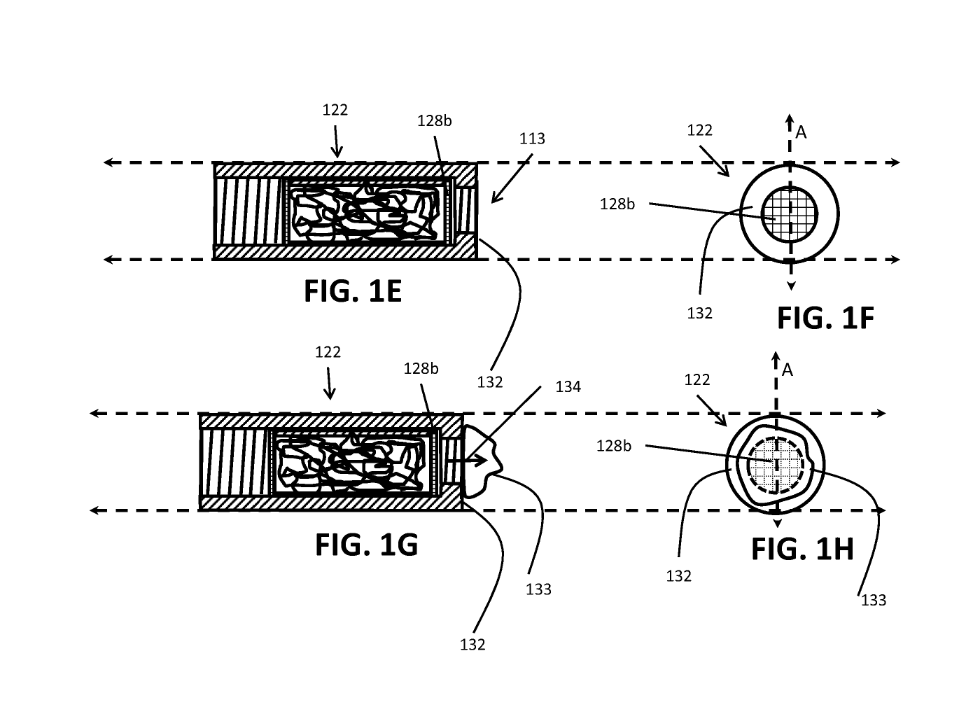

One embodiment concerns a pressurized tank foam dispenser 100 as shown in FIGS. 1A to 1H. A two gallon 456F tank from Solo U.S.A., Newport News, Va., was used in usage trials along with the accompanying pump head and wand. It was modified as discussed below.

The example discussed in FIGS. 1A to 1H can include a supply tank 101, a pump head 102, a hose 103, a wand 104, and an outlet assembly 105. The outlet assembly 105 in this example can be located on the distal end 106b of the wand 104 and have a mixing chamber 122 for creating or conditioning a foam. The wand can have the same length of wands used in the prior art. Typical uses call for a wand between 25 and 100 cm. Other lengths may also be desirable for specialty uses.

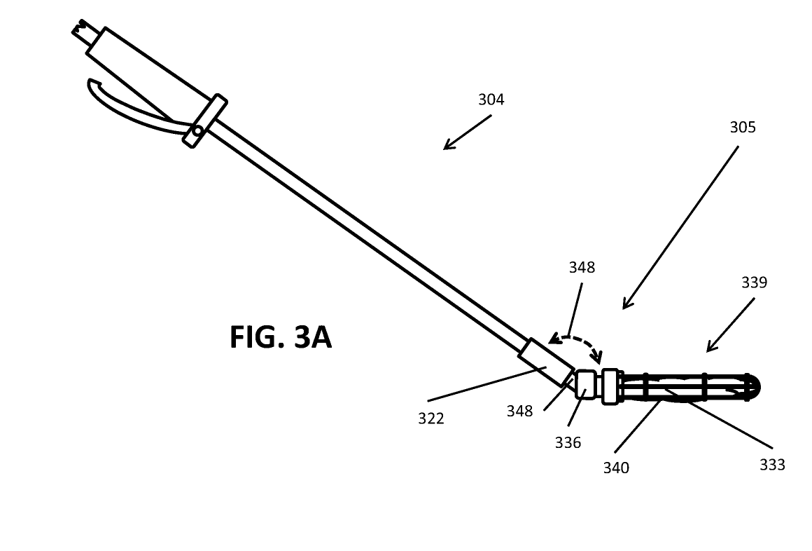

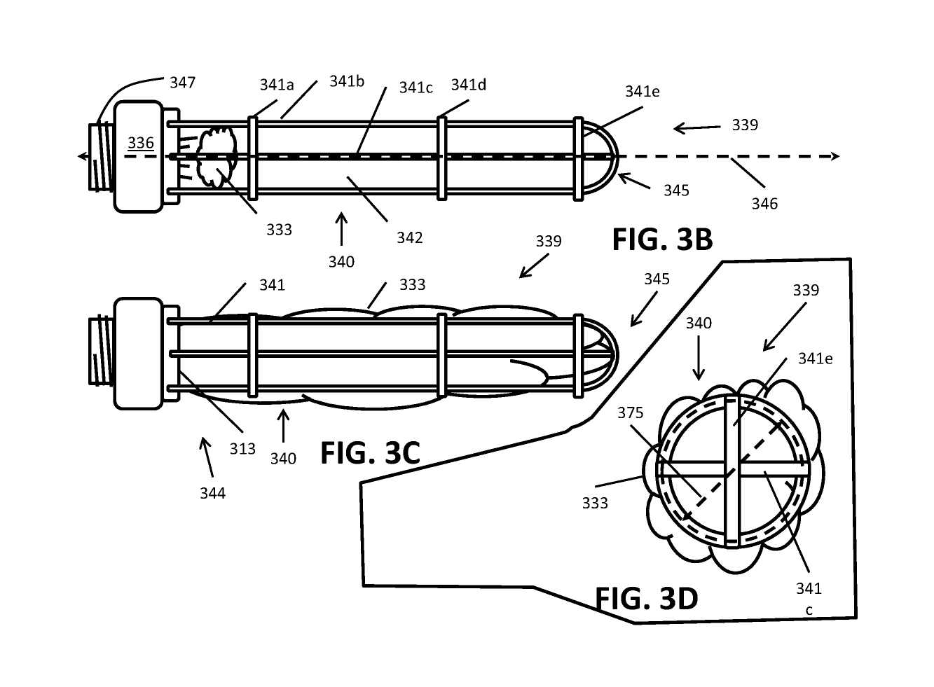

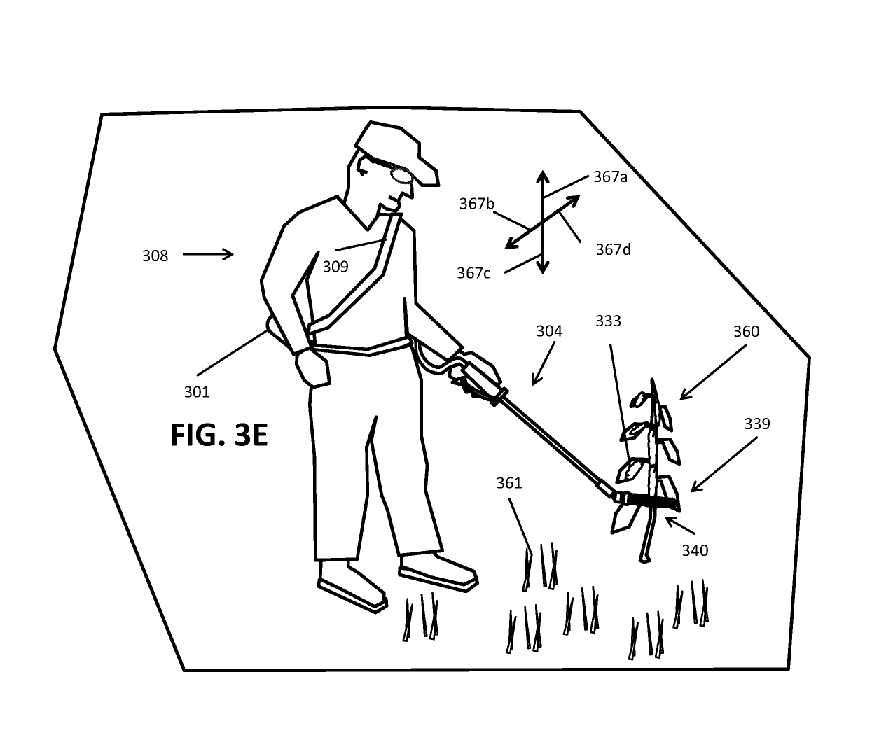

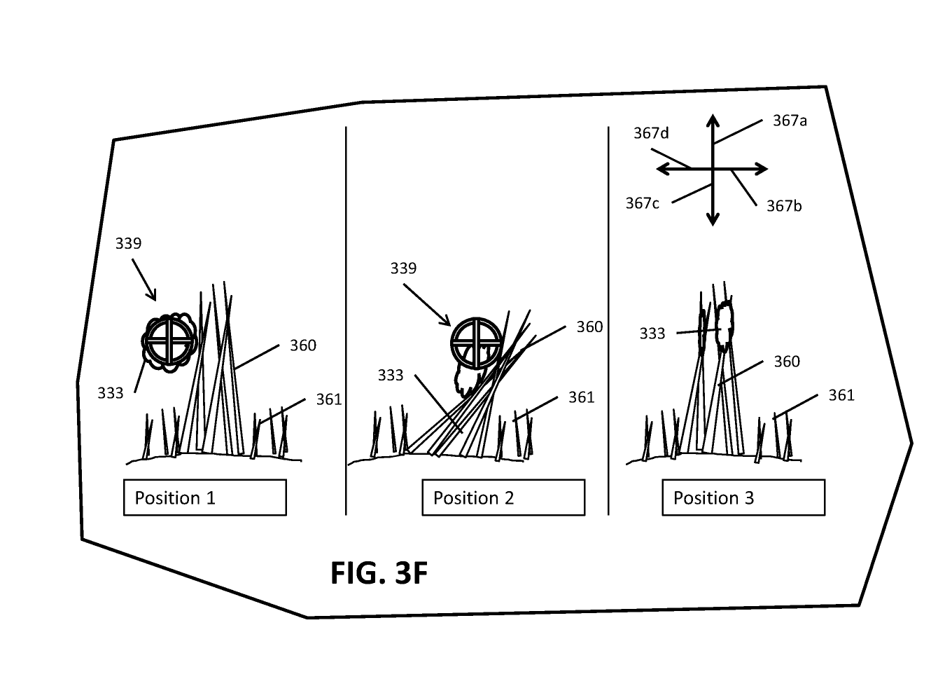

The supply tank 101 can be of varying sizes. This dispenser 100 is one that might typically be carried by a user by the pump handle 107 or slung on the back of an operator 108 and carried by a strap 109 as shown in FIG. 3E. The supply tank 101 might hold approximately 0.20 to 20 liters and more preferably might hold approximately 0.5 to 10 liters. For other applications larger tanks can be employed to use on carts, with vehicles, etc. Smaller tanks can be used for handheld versions.

The tank 101 and supply line 110 can be pressurized in the same way prior art tank sprayers are commonly pressurized. The user grasps the pump handle 107 and pumps it up and down to add air to the tank 101 to pressurize it. This can pressurize the tank 101 and the portion of the supply line 110 up to the wand handle 111 where the shut-off valve (not shown) can be located and controlled by the wand lever 112. (The supply line 110 can include fluid in the dip tube 114, the hose 103, the wand 104, the outlet assembly 105 (up to the nozzle 113), and fittings and connectors in between.)

Unlike prior art pressurized tank systems that typically operate best with pressures ranging from approximately 0.68 to 2.07 bar (approximately 10 to 30 psi), the present invention can generally require very low pressures to generate and dispense high quality foam. The pressure for this dispenser 100 can generally range from 0.5 to 20 psi and more preferably from 0.5 to 15 psi; and still more preferably from 0.5 to 10 psi. For some uses, the most preferable range can be from approximately 0.5 to 5 psi. Therefore the tank 101, pump head 102, hose 103, hose fitting 119, and wand 104 in this example could be less robust than prior art ones.

Once the tank 101 is filled with a liquid 118 (such as an herbicide solution or other foamable liquid) and pressurized, it can be operated. By depressing the wand lever 112, the operator 108 can cause liquid to be drawn through the bottom of the dip tube 114a. In operation when the wand lever 112 is depressed, the supply line 101 can be pressurized up to the nozzle 113 because the system can be made to be airtight up to the nozzle 113. The purpose of the nozzle 113 can be to control the direction or characteristics of the flow of the foam 133.

The dip tube 114 of the present invention can have a vent 117. The purpose of the vent 117 can be to introduce pressurized air from the headspace 116 into supply line 110 to help create foam of high quality. The vent 117 can preferably be positioned on the dip tube 114 so that it is located in the headspace 116 when the tank 101 is filled with liquid. The vent 117 should remain above the liquid level during use of the dispenser 100 in order to prevent the liquid 107 in the supply tank 101 from entering the vent 117.

The dip tube 114 can have an inside diameter of approximately 2 to 10 mm depending on various factors such as the volume of liquid desired to be dispensed and the size of the dispenser 100. For most hand carried dispensers 100, the vent 117 can be a very small, round opening in the wall of the dip tube 114—e.g., the vent 117 might have a diameter between approximately 0.3 mm and 2 mm and more preferably between 0.6 mm and 1.5 mm and even more preferably between 0.7 mm and 1.3 mm.

If the vent 117 is too large, the dispenser 100 may create poor quality foam and slow foam production. If the vent 117 is too small, insufficient air will be mixed the solution 107 and the foam may become watery. Small changes in the size of the vent 117 can make big differences in foam quality. Therefore, it is important that the vent 117 be properly sized.

Dip tubes in the prior art have typically been made of pliable or elastic materials such as certain plastics. A material often used for dip tubes is extruded polyethylene. Use of such materials makes sense for many reasons besides just cost. For instance, if a stiffer or more rigid material such as brass tubing were used for dip tubes, the dip tubes could be easily become bent and crimped or otherwise permanently deformed, for example when screwing-on or screwing-off the pump head 102 for filling the tank 101.

Although pliable materials such as polyethylene have worked reasonably well for standard sprayers, they have not worked so well for foam dispensers that have vents in their dip tubes for foam production. To create the dip tube vents in prior art foam dispensers, manufacturers have generally drilled into that soft, elastic polyethylene of the dip tube to create a vent. However, materials like polyethylene can be very difficult to drill with precision. The drill can distort the shape of the plastic making imperfections in the vent; and the plastic from the drilled opening—the chips or swarf—may not separate cleanly from the surrounding plastic, leaving dangling pieces of plastic. Problems may result: First, it can be difficult to maintain tight tolerances in creating the vent during production. Second, the size of the vent can change during usage of the sprayer. For example, the dangling pieces of swarf may change position during use of a dispenser. Or, imperfections in the vent surfaces can collect matter such as particles in the solution and possibly obstruct the opening. Third, even if an opening were drilled with precision to create an undistorted hole in a prior art dip tube, usage, cleaning, etc., can create wear in the sides of the vent and change the dimensions of the prior art vent.

To correct these shortcomings, the dip tube 114 of the present invention can have vent 117 formed with precision. To do this, a vented connector 115, in this example a tube splicer made of metal (e.g., brass or stainless steel) can be inserted between two sections 114a, 114b of the dip tube 114. The vent 117 can be formed in the wall of the connector by drilling or other means. A vent 117 sized at 0.9 mm with a 0.32 mm ID dip tube 114a worked well in usage trials.

Thus, when the dispenser 100 is activated (in this example, by depressing the lever 112 on the wand handle 111), liquid is drawn into the dip tube 114. As the liquid passes through the vented connector 115, air from the headspace 116 can be drawn into the dip tube 114 and mixed with the liquid. This can create a fluid stream with some bubbles (probably of varying sizes and quality). The fluid can then enter the hose and then the proximate end 106a of the wand 104. Thus, the vent 117 can act as a gas inlet to the supply line 110 by introducing a gas (typically air stored in the headspace 116) into the supply line 110.

In this example, the distal end 106b of the wand 104 has an outlet assembly 105 with a mixing chamber 122. The mixing chamber 122 can have an enclosure 123 creating a void 124 into which a cartridge 125 can be inserted as shown in FIGS. 1D to 1F. The cartridge 125 can include a tube 126. The tube 126 can be hollow. Preferably, the tube 126 can be translucent or clear so that its contents can be viewed.

The cartridge 125 can contain a mixing medium 127 such as stainless steel wool. The cartridge 125 can be from about 1 to 30 cm in length for many applications; and more preferably from about 2 to 15 cm; and still more preferably from about 3 to 8 cm. The diameter can be from about 0.2 to 4 cm for many uses and more preferably from 0.5 to 2. Different dimensions could be appropriate for dispensers of different sizes.

A mesh screen 128a can enclose the proximate end and another mesh screen 128b the distal end of the cartridge 125. The screens 128a, 128b can be made of a variety of materials, e.g., metal wire cloth, plastic. For example, during usage trials, a 304 Stainless Steel Wire Cloth Disc, 60×60 Mesh was found suitable for both the proximate and distal screens 128a, 128b.

The cartridge 125 can be held within the mixing chamber enclosure 123 by a retainer 129—in this instance the retainer 129 is an O-ring. The retainer 129 should preferably hold the cartridge 125 in place when, for instance, the mixing chamber 122 is not attached to the wand 104. When the mixing is attached to the wand 104, the retainer 129 can form a seal and help ensure that fluid in the supply line 110 does not bypass the mixing medium 127 inside the cartridge 125. The mixing chamber 122 can be attached to the wand tube 121 in various ways such as by a first threaded connection 130. Distal attachments can also be connected to the mixing chamber 122 by a second threaded connection 131.

During usage trials, it was found that the mixing medium 127 should preferably be packed in the cartridge 125 relatively loosely. In addition, fine steel wool (316 stainless steel, fine grade available from McMaster Carr) produced drier foam with smaller bubbles than coarse steel wool. Therefore, fine steel wool is preferable to coarse as the mixing medium 127 in the cartridge 125. For a cartridge 125 with a body having a finished length of approximately 5.0 cm and an inside diameter of approximately 1 cm, a wad of fine steel wool weighing approximately 0.2 g distributed relatively uniformly throughout the volume of the cartridge 125 produced excellent foam.

To manufacture the cartridge 125, one of the screens 128a, 128b can be installed on the cartridge tube 126. For example, the distal screen 128b can be heat welded on. Next, the appropriate amount of mixing medium 127 can be installed in the tube 126. The mixing medium 127 can be manipulated to ensure the mixing medium 127 is distributed relatively uniformly inside the tube 126. The proximate mesh screen 128a can be mounted, e.g., by heat welding.

The cartridge 125 for containing the mixing medium 127 offers a number of advantages. First, the cartridge 125 can help ensure consistency in the installation of the mixing medium 127. The contents of the cartridge 125 can be easily viewed if the tube 126 is made of a translucent or clear material. During viewing (and before closure with both screens 128a, 128b) the mixing medium 127 can be manipulated to ensure proper installation. Also, any part of the mixing medium 127 that extends outside the cartridge 125 such as strands of steel wool extending through the mesh screens 128a, 128b can easily be trimmed to ensure that those strands do not affect seals or connections.

Second, the cartridge 125 can be easily removed for inspection, cleaning, or replacement by the user. If the retainer 129 is removed, the cartridge 125 can be sized to easily slide out of the mixing chamber enclosure.

Third, with the cartridge 125, the operator 108 doesn't have to directly handle the mixing medium 127 during removal and reinstallation for inspection, cleaning, and maintenance. Handling mixing medium 127 such as steel wool can be unpleasant—strands can poke skin; it can also result in breakage and loss of strands which can in turn affect dispenser performance when reinstalled.

Fourth, the cartridge 125 makes reinstallation of the mixing medium 127 into the mixing chamber 122 much easier. Without the cartridge 125, a mixing medium 127 like steel wool would have to be carefully packed to ensure uniform distribution in the mixing chamber void 124. The cartridge 125 makes reinstallation simple because it helps ensure the mixing medium 127 retains its desired shape and distribution. Fifth, the cartridge 125 can be disposable. Mixing medium 127 can be difficult to clean if clogged or contaminated. By having a cartridge 125, a clogged cartridge 125 can easily be removed and a new one installed—even in the field. Sixth, the cartridge 125 can help ensure that the mixing medium 127 is fully contained within the mixing chamber enclosure. For instance, the tube and the screens 128a, 128b can help prevent mixing medium 127 from migrating downstream during use. Seventh, a user could select from a range of cartridges (not shown) a particular cartridge 125 to produce desired foam qualities. For example, a user might select a cartridge 125 with a very small amount of mixing medium 127 made with coarse steel wool for one use and a cartridge 125 with tightly packed fine steel wool for another use.

During operation, when the fluid reaches the mixing chamber 122 it can be conditioned by the mixing medium 127. After conditioning in the mixing chamber 122, the foam can travel through a nozzle 113 consisting in this example of a single orifice 120. As shown in FIGS. 1A to 1H, the nozzle 113 can be a wide single orifice 120, approximately 2 cm in diameter. (The nozzle 113 can also function as the female portion of the second threaded connection 131 for attachments.) As shown in FIG. 1F, the distal screen 128b of the cartridge 125 can be visible through the nozzle orifice 120.

This outlet assembly 105 can be used for foliar applications—where foam is applied to a target plant 160 from a distance (not shown). That distance should preferably be close—from touching the target surface to roughly 10 cm. For example, a small glob of foam 133 can be projected under low pressure at a target surface such as on plant foliage. Such applications can be quite precise and can generate very little mist or off-target foam spray. For such uses, the pressure used might be approximately 5 to 10 psi.

As shown in FIG. 1B, the outlet assembly 105 can also be used for spot wiping or spot treatments where foam 133 is applied by wiping foam 133 on and transferring foam 133 to a target plant 160. The wiping surface can be considered to be the parts of the outlet assembly 105 that can temporarily retain foam 133 ejected through the orifice 120. This can include the area of both the nozzle face 132 and the orifice 120, since it was found during testing, especially at pressures below 5 psi, that foam can readily span from the nozzle face 132 over the orifice 120 and be temporarily retained there as shown in FIGS. 1G and 1H.

With wiping, as it is understood here, the wiping surface can but need not directly contact the target surface. For instance, the foam 133 can be gathered on the nozzle 113—in and around the nozzle orifice 120 and on the nozzle face 132—in this example the surface on the perimeter of the nozzle orifice 120. FIGS. 1G and 1H show foam 133 in the nozzle orifice and on the nozzle face 132. The nozzle orifice 120 or the nozzle face 132 can directly contact the target surface.

Alternatively, the pile of foam 133 on the nozzle 113 can simply be brought in contact with the target surface and be transferred to the target without any direct contact between the nozzle 113 and the target. For such uses, the pressure used might be approximately 0.5 to 5 psi.

The dispenser 100 can have distinct advantages over prior art dispensing systems. One key advantage is that the nozzle orifice's 120 wide opening can limit the amount of destruction of the bubble structure of the dispensed foam 133. If foam 133 is dispensed through conventional spray nozzles, small drops of liquid can be dispensed along with any foam 133 that has been produced. These small drops can easily drift or otherwise move off-target. This may occur with prior art dispensers because the small orifices, high pressures, and pressure changes can destroy foam bubbles before they are dispensed.

Another advantage of the dispenser 100 over prior art systems is that it can utilize low pressure. Testing was done using a pressure gauge attached to a prototype resembling the dispenser 100. A foamable solution was used containing tap water and 0.8% 225DK (a surfactant available from Jarchem Industries, Newark N.J. It was found that pressures in the dispenser 100 below 20 psi were preferable for wiping; pressures below 15 psi were more preferable; and pressures below 10 psi were still more preferable. (Moreover, in many cases where accuracy was critical, pressures below 5 psi are most preferable.) At these low pressures, high quality foam was produced, and foam could more easily be retained on the wiping surface. At higher pressures, in contrast, foam was ejected in a stream and did not easily collect on the wiping surface.

Another advantage of the dispenser 100 over prior art systems is that the wand 104 can be used to reach a target surface such as the leaves of a low-lying target weed as shown in FIG. 1B. Foam 133 can be ejected onto foliage and the nozzle 113 can be used to spread the foam 133 over more of the foliage. In addition, the perimeter of the distal end of the nozzle 113 can be used as a surface on which foam 133 can collect as shown in FIGS. 1G and 1H. This can allow foam 133 collected on the wiping surface to be wiped. Thus, for example, if foam 133 is wiped on one surface and not all of it is used up, the remaining foam 133 can be wiped on additional surfaces until more foam 133 is needed.

Still another advantage of dispenser 100 is the location of the mixing chamber 122. By having the mixing chamber located distally on the wand 104, the foamable solution is conditioned near where it will be ejected from the nozzle 113. This means the foam will be less likely to break down or be destroyed by extended travel through the supply line 110. In addition, there may be pauses between uses of the dispenser 100. During those pauses, the foam can break down. A distally place mixing chamber 122 reduces the amount of foam 133 that can be broken down in the supply line 110 when the dispenser 100 is not in use.

The outlet assembly 105 shown in FIGS. 1A to 1H can, however, have some limitations. Although relatively precise applications of foam 133 can be made to a surface such as plant foliage, foam 133 can surge out the nozzle 113 or come out in spurts. This may be due in part to the way foam 133 from pressurized tank systems is created. Use of a vent 117 may introduce variations in the amount of air in the supply line 110. These variations in the amount of air in the supply line 110 at any given point along that supply line 110 may cause the surging or spurting. This can lead to the foam 133 splattering on the surface to which it is applied, especially if the operator 108 dispenses foam 133 for brief periods of time such as under one second.

In addition the nozzle face 132 may provide a relatively small wiping surface on which foam 133 can collect as shown in FIGS. 1G to 1H. Moreover, the nozzle face 132 may not generally be considered to be in the path 134 of the ejected foam 133. In fact, it is roughly at a right angle to the path 134 of the ejected foam 133. Therefore, it can be difficult to collect foam 133 on the nozzle face 132. To cause foam 133 to gather on the nozzle face 132 small amounts of foam 133 can be ejected at low pressure in close proximity to a target plant 160. However it can be difficult for the user to steadily meter out the requisite amount of foam 133 necessary to resupply the wiping surface.

It should be noted that the dispenser 100 related to FIGS. 1A to 1H introduces a gas (air) into the supply line 110 stored in the headspace of the 101 supply tank. Air or a gas can be introduced into the supply line 110 (or into the devices below) in other ways. For example, an independent air tank, independent air and liquid pumps can be used, or an air induction nozzle that sucks ambient air into the supply line 110 can be used.

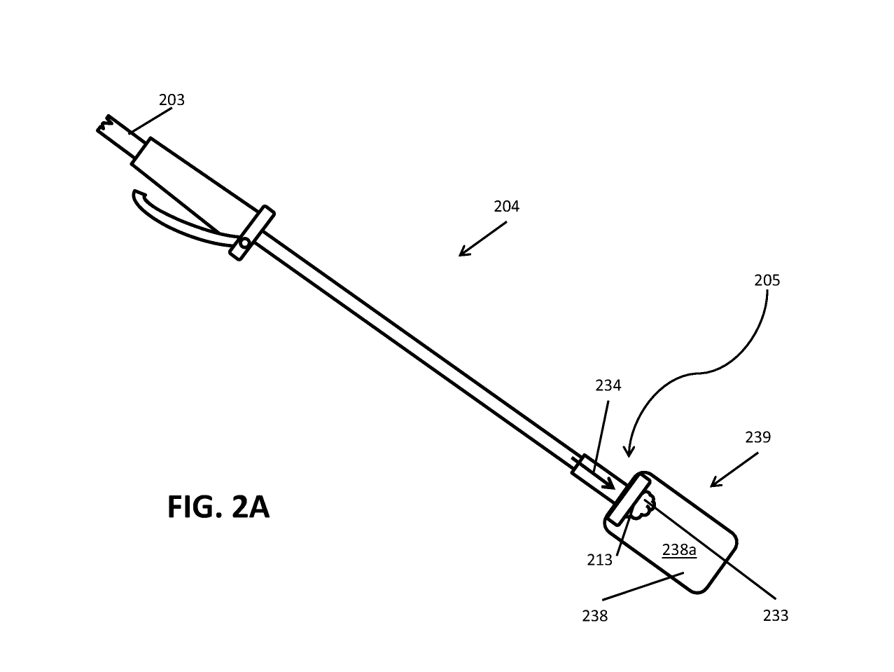

FIG. 2A shows another example of an outlet assembly 205 and wiper 239 mounted on a wand 204 (with a portion of hose 203 visible) that resembles wand 104. This wand 204 can have an outlet assembly 205 that resembles outlet assembly 105 in some ways but differs in other ways. The wiper 239 can be a flat piece (substantially two-dimensional without marked projections or depressions), in this case a paddle 238 (or spatula). The paddle 238 can be used for wiping. The paddle 238 can be of varying dimensions. The length (the direction in line with the wand) might preferably be from 3 to 15 cm and the width from 3 to 8 cm in this embodiment.

In use, foam 233 can be dispensed from the nozzle 113 onto the paddle 238, and the paddle face 238a can function as the primary wiping surface. The paddle face 238a can then be wiped across target surfaces such as foliage, since most of the foam 233 will be ejected onto it.

The paddle 238 can be made of different materials. For example, it can be made of an impervious material such as a rubberized material, similar to that used for floor mats. This means primarily one side of the paddle 238 would be used for wiping. Having a pervious material such as a mesh would mean both sides could be used for wiping. The paddle 238 material would preferably be flexible.

Unlike the wiping surface of the dispenser wand 104 shown in FIGS. 1E to 1H, the paddle 238 can be generally in the same plane as the path 234 of the ejected foam 233. This can increase the likelihood that ejected foam 233 will attach to the wiping surface. As much foam 233 as is necessary can be wiped from the paddle 238 onto a target surface. Any remaining foam 233 can be used on additional target surfaces. An additional advantage of this embodiment can be that a substantial amount of foam 233 can collect on the paddle 238 because of the large surface area of the paddle face 238a. Yet another advantage is that the paddle 238 can be used much like a spatula to spread foam 233 on the target surface.

A different outlet assembly 305 mounted on a wand 304 is shown in FIGS. 3A to 3F. This outlet assembly 305 can include a wiper 339 that can be attached to an elbow connector 348 with a lock nut 336 and threaded attachment fitting 347. The wiper 339 can be an elongated frame in the form of a cage 340. The cage 340 can have cage members 341 separated by openings 342. (Individual cage members are shown in FIGS. 3B and 3D as 341a, 341b, 341c, 341d, 341e.) In this way, the cage 340 can form a skeleton framework. As shown in FIGS. 3B to 3D, when foam 333 is ejected from the nozzle 313, it can generally follow the path of the longitudinal axis 346 and enter the cage 340. The foam 333 can attach to the cage members 341 as shown in FIGS. 3B to 3D.

The cage 340 as shown in FIGS. 3B to 3D might be approximately 10 to 20 cm in length and be 2 to 6 cm in diameter 375. The distal end 345 of the cage 340 can be closed, i.e., the structure of the cage 340 can enclose the distal end 345.

The members 341 in this example can be made of metal wire with cross-members, e.g., 341a attached to longitudinal members 341b. The members 341 can be attached to each at points of intersection, e.g., by spot welding. The members 341 can form a round nose at the distal end 345.

The members 341 in this example might preferably be about 1 to 3 mm in diameter. If a stiff material such as a stiff metal were used as components, the cage 340 could form a stiff structure that would under normal use not bend significantly.

Having a relatively stiff frame for the wiper 339 can be preferable for certain applications. In FIG. 3E, the user may be applying a foamed herbicide to a target plant 360—in this case a small weed sapling that is positioned amongst desirable plants 361. Spraying such a plant with conventional sprayers can be problematic because off-target spray would likely hit the desirable plants 361. The application of the foam 333 such as foam herbicide could work as follows: the user can eject foam 333 into the distal end 345 of the cage 340 as shown best in FIG. 3B; the cage 340 can fill partially or completely with foam 333 as shown in FIGS. 3C and 3D; the foam 333 can be sufficiently dry that it can have a tendency to cling to the members 341 of the cage 340 as shown in FIGS. 3C and 3D. The cage 340 can act as a partial containment and a shaper of the foam 333, while still allowing foam 333 to move outside the cage 340 when needed. One way to move the foam 333 outside the containment of the cage 340 can be the dispensing of additional foam 333 from the nozzle 113 and thereby forcing the foam 333 inside the cage 340 out the openings 342. The wiper 339 can then be moved up 367a and down 367c the height of the target plant 360 or horizontally 367b and 367d. Foam 333 can be deposited on the foliage of the target plant 360 including the stem and tops and undersides of leaves (not visible).

Another way the wiping technique can be used with the wiper 339 is shown in FIG. 3F which does not show the wand 304 but just the wiper 339. Although the target foliage 360 resembles grass, the same general technique can be used on various plants including woody ones, forbs, etc. To do this, the operator 308 can position the cage 340 near the target foliage with sufficient foam 333 clinging to the cage 340 as shown in Position 1; the cage 340 can be drawn forward 367b across the foliage as shown in Position 2.

As shown in Position 2, the cage 340 is being drawn in a direction that is generally perpendicular to the longitudinal axis 346 of the cage 340. As the cage 340 is brought near or brought in contact with the target foliage 360, foam 333 can be transferred to the foliage 360. Once the foam 333 contacts the foliage 360, the foam 333 can be transferred to the foliage 360. Some foam 333 and liquid will continue to cling to the cage 340 and some will transfer to the foliage 360 as shown in Position 2. In addition, as shown in Position 2, movement of the cage 340 across the foliage can bend the foliage. This bending can bunch up the foliage creating a greater surface area for transfer of foam 333 to the foliage. As shown in Position 3, after the wiping action has been completed, foam 333 clings to the target foliage 360.

The transfer of the foam from a wiper such as a cage to a target plant can be controlled in various ways: First, the level of foaminess can be varied by changing the make-up of the foamable solution. For example, more foaming agent can be added, generally making the foam 333 foamier, i.e., have more entrained air. Second, the mixing medium 127 can be changed to produce a foam 333 with a different quality (such as by changing the cartridge style as discussed above). Third, the amount of foam 333 ejected into the cage 340 can be varied. For example, the operator 108 can dispense a small glob of foam 333 with a short press of the lever 112 or continuously dispense foam 333 with a long press of the lever 112.

Fourth, the way in which the wiping action is done can change the application—for instance, pressing down very lightly and using the wiper's distal end 345 can dab a very small amount of foam for a precision application on a target plant 360. Pressing down 367c harder on the foliage and slowing the wiping action may cause more foam 333 to be transferred.

Other techniques can be used to change the way foam 333 is transferred to foliage: foam 333 can be dabbed on (not shown) the foliage 360; the wiper 339 can be brought down on the tips of foliage 360—thereby allowing more foliage tips to enter inside the cage 340 and the transfer of foam 333 can take place inside the cage 340. The wiper 339 can be moved in many different direction or in different patterns to transfer foam 333. This makes the dispenser equipped with the wiper 339 highly versatile in wiping foams created from liquid mixtures such as ones containing herbicides. (Note that many of these same techniques for controlling the transfer of foam to a target plan can be used with the other examples of wipers detailed above and below.)

The transfer of the foam 333 can also be varied by the amount of pressure in the dispenser 100 for ejection of foam 333 into the cage 340. Generally, the pressures used could be similar to those for dispenser discussed above in relation to FIGS. 1A to 1H. However, because the cage 340 can partially impede the foam 333 as it is ejected from the nozzle 113, the pressure used can preferably be higher, while still allowing for foam to be retained by the wiper 339. A pressure between approximately 0.5 and 20 psi is preferable; a pressure between approximately 1.0 and 15 psi is more preferable; and a psi between approximately 5 and 10 psi is still more preferable.

The wiper 339 and cages in general can offer other advantages. First, the wiper 339 shown in FIGS. 3B to 3D can limit the problems associated with surging, spurting, and splattering. If for example, a glob of foam 333 is ejected from the nozzle 113 as shown in FIG. 3B, the cage 340 can help contain that glob as shown in FIGS. 3C and 3D. As more foam 333 is ejected, the additional foam 333 merely adds to the glob and the glob generally takes on the shape of the cage 340. Thus, the cage 340 can greatly increase the control and precision with which foam 333 is applied to a target surface.

Second, by controlling ejected foam 333, the wiper 339 not only can prevent excessive foam 333 from being applied to a target surface. It can also save the foam 333 within and on the structure of the cage 340 for later application to another target plant. Moreover, the collected foam 333 can be saved in the form of the cage 340 (i.e., in this example in the shape of a rod or solid tube) for a substantial period of time. The dispenser can also produce foam 333 that does not quickly break down or collapse. For example, foam 333 ejected into the cage 340 can be held for multiple seconds or even minutes without dripping liquid from the cage 340. This can be highly advantageous. It can allow a user to make spot treatments of target plants in different locations without dripping herbicide onto desirable vegetation or other non-target surfaces. This contrasts with prior art wiping systems that can drip profusely between spot applications.

Third, the wiper 339 can form the foam 333 in a desirable shape for wiping purposes. In this example, as mentioned above, the cage 340 can form the foam 333 in an elongated, rod-like shape. This rod-like shape can be advantageous for providing a large wiping surface that can wipe foam 333 along the length 346 of the wiper 339 as shown in FIG. 3B or, as shown in FIG. 3D, in an upward direction 367a, forward 367b, downward 367c or backward 367d. This can be useful for wiping for grasses or patches of weeds using mostly the length 346 of the wiper 339 and the bottom and sides. In addition, the cage 340 can be drawn upward 367a to allow application largely from the top of the wiper 339 to the undersides of leaves. However, the broad wiping surface can still be used to apply foam 333 in the cage 340 with precision to small surfaces. For example, only the round nose of the cage 340 on the distal end 345 can be brought near or in contact with a plant surface to make a precision application to a small area (not shown).

Fourth, the wiper 339 can provide a structure that limits slippage of the foam 333 from the wiping surface. For example, the foam 333 ejected onto the paddle 238 wiping surface discussed above may likely slip as the foam 333 drains and liquid collects on the paddle face 238a. The cage 340 however provides a three-dimensional structure for the foam 333 to attach to. The cage 340 structure can limit foam 333 slippage because the cage 340 can more readily contain the foam 333.

Fifth, the wiper 339 can effectively be used to deposit, stretch, and spread foam 333 over a target surface 360. Foam 333 can be deposited when excess foam 333 easily transfers from the cage 340 to a target surface. The stretching can occur as foam 333 that is clinging more tightly to the cage members 341 is stretched between those members 341 and the plant surface 360. The spreading can occur as foam 333 which has already been transferred to the target surface 360 is spread over a larger area of that target surface 360. In this way, the cage 340 can be used much like a spatula.

Sixth, the wiper 339 can both support the foam 333 but still have large openings 342 for the transfer of foam 333. The vast majority of the frame's envelope (which can be considered the divide between the interior and exterior of the cage 340) can be openings 342 thus allowing ready transfer of the foam 333 from almost any side of the cage 340. In this way the wiping surface can be larger than the surface area of the cage members 341.

Seventh, the elongated structure of the wiper 339 can easily be horizontally positionable by the operator (not shown) during dispensing so that the length of the wiper 339 is largely parallel to the ground. This has the advantage of creating a broader area for wiping. Instead of being limited to treating largely one plant at a time such as with wiper 139 and 239, the elongated structure of wiper 339 allows the potential to treat multiple plants at once, especially if a sweeping motion is used while wiping. (Many of the advantages listed here apply to wipers listed below.)

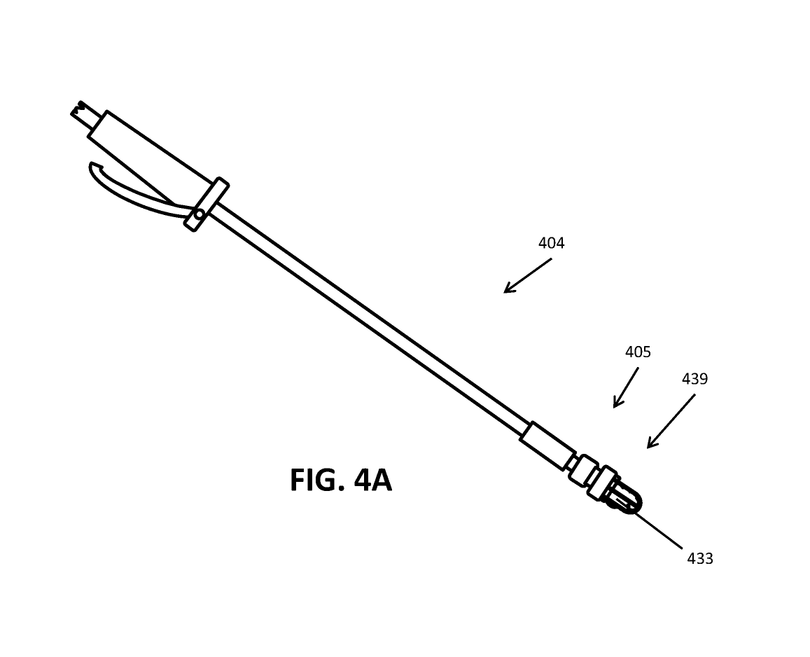

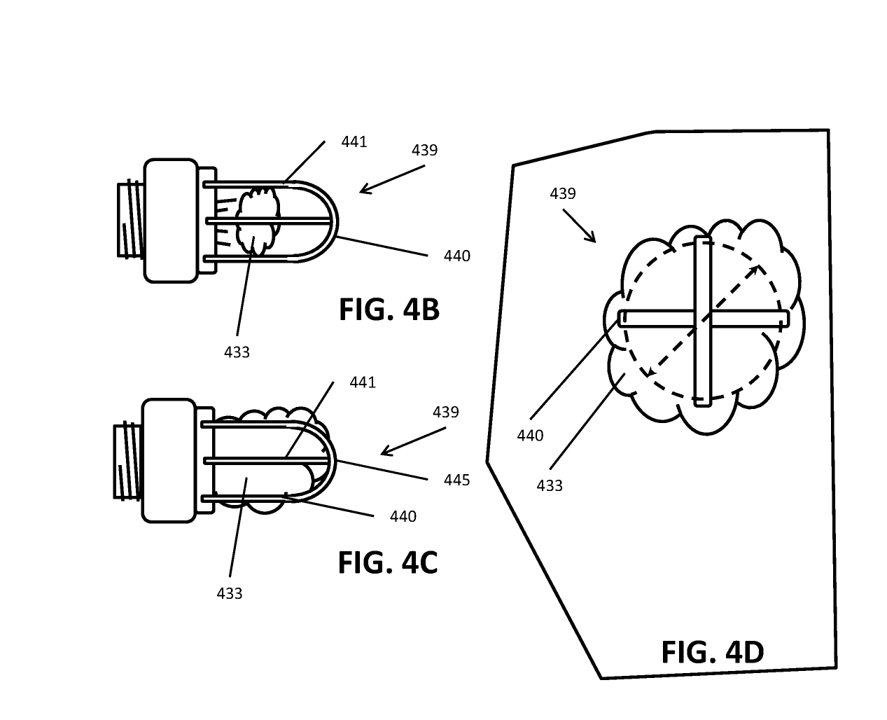

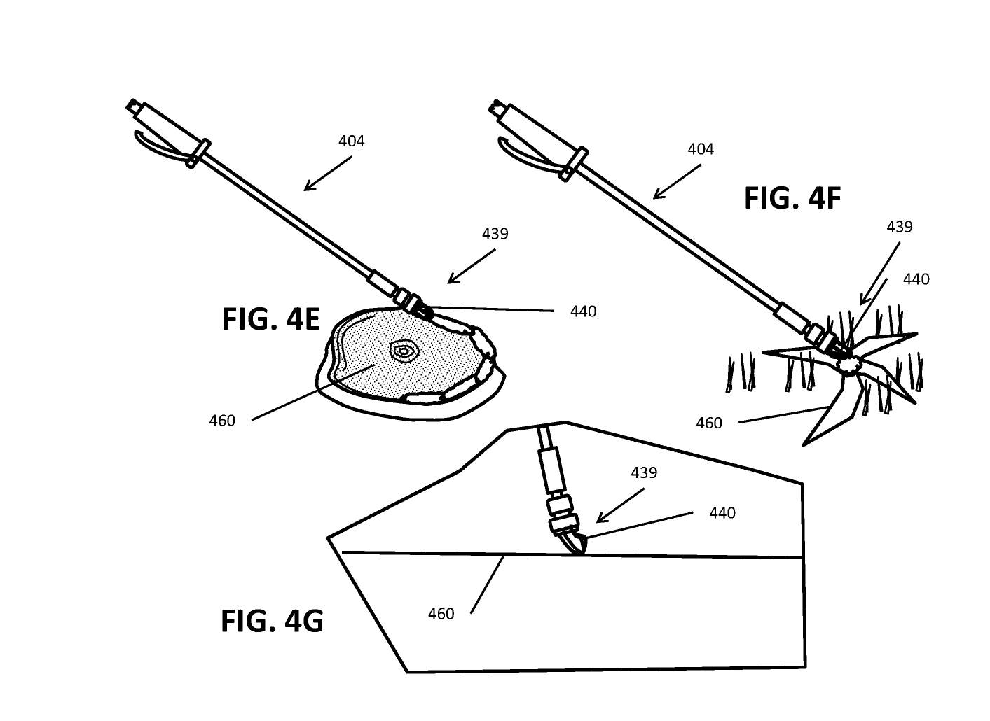

FIGS. 4A to 4F show another example of a wand 404 and outlet assembly 405. It can resemble outlet assembly 305 with certain differences. The length of the cage 440 can be short—in this example, perhaps a length of 2 to 6 cm, although different length may be suitable for other uses.

In addition, the wiper 439 can have other differences. The cage members 441 can be made of a flexible material such as spring steel wire similar to the wires used for a whisk. (Many other materials such as nylon or plastic string may also be suitable.) In addition, the cage members 441 need not be attached to each other distally (for example, with spot welds or cross members as discussed above). Such a wiper 439 might be useful for certain applications. For instance, it might be especially useful for precision dabbing of foam 433 on plant surfaces 460 using the cage's distal end 445. If very little of the foam 433 were intended to be transferred to a target, then the cage 440 could be lightly brushed against or brought near the target. On the other hand, if the operator 108 wished to transfer more foam herbicide, the cage 440 of such a wiper 339 could be pressed against the target 460. FIG. 4G shows how the cage 440 might deform when pressed against a target surface 460. When the cage 440 is deformed, more foam (not shown in FIG. 4G) could be transferred to the target surface 460. In addition, construction of the cage 440 could be economical since lighter weight materials and simplified manufacturing processes could be used. Alternatively the cage members 441 could be made of extruded plastic string similar to that used for weed whips. Such a cage 440 could be still more easily deformed when pressed against surfaces. Such a cage 440 would likely also reduce manufacturing costs even more.

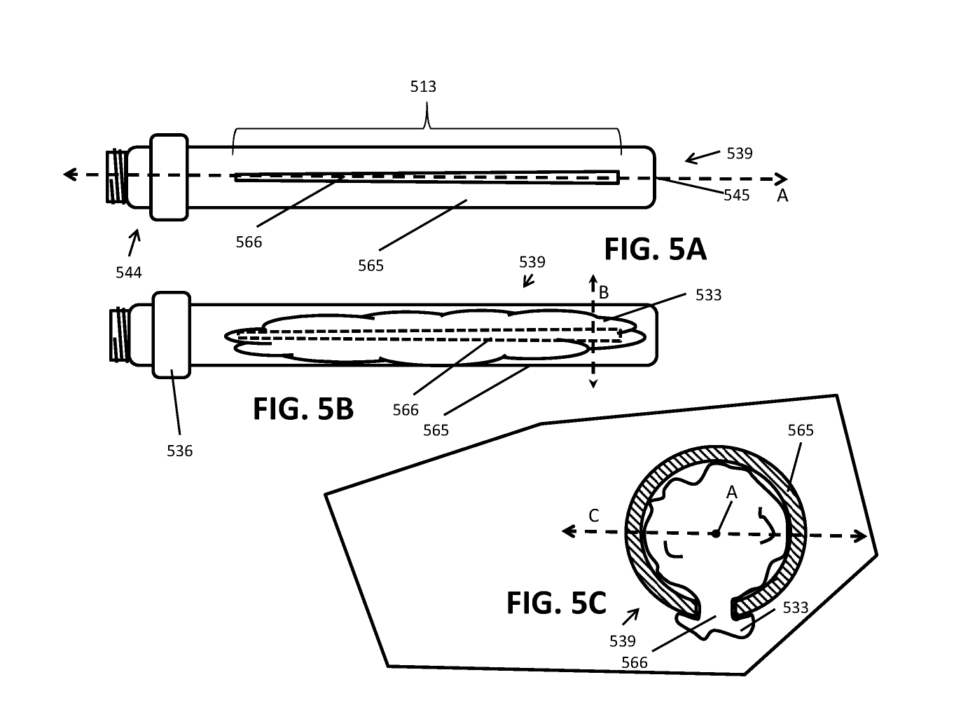

FIGS. 5A to 5C show another example of a wiper 539. It can resemble the examples given above with differences. The wiper 539 can be a hollow elongated tube 565 with a closed distal end 545. Foam 533 can fill the tube 565 and be released onto the wiping surface from a slot 566 in the wall of the tube 565.

The slot 566 can widen towards the distal end 545 where pressure can be lower inside the wiper 539. This can help equalize the amount of foam released on the proximal 544 and distal ends 545 of the wiper 539. This can also make for a release of an even amount of foam along the slot. The slot 566 can preferably extend along a substantial portion of the length of the tube 565. For most uses, the tube 565 can preferably be about 1 to 8 cm in diameter and can preferably have a length of about 3 to 30 cm. For this example, the slot can preferably be about 0.1 mm to 2 mm wide and about 1.0 to 29 cm in length. Thus, the slot 566 and tube 565 can make up an elongated nozzle 513 that ejects an elongated stream of foam 533.

The tube 565 can preferably be made of a stiff material such as brass, stainless steel, or plastic tubing. Generally, it is preferable, when the wiper 539 is brought in contact with a plant, that the wiper 539 bend the plant as opposed to the plant bending the wiper 539. In addition, the wiper 539 is preferably deployed in a horizontal position. It would not be preferable to have the distal end 545 sag. Crack-resistant polyethylene tubing having an ID of ⅜ in. and OD of ½ in. available from McMaster Carr has a suitable stiffness for most uses. In addition, the tube 565 should be firm and not collapse; otherwise the tube could collapse or kink in use. Again, a straightened piece of the polyethylene tubing just described would be suitable.

One advantage of this wiper 539 is that foam 533 can be ejected along a substantial portion of the surface of the wiper 539. In contrast wiper 339 above and wiper 639 below, eject foam at the proximate end of the wiper. Especially with wiper 339, having a nozzle 313 only on the proximate end can lead to foam 333 bunching up on the proximate end. This bunched up, plug of foam 333 can prevent foam from being deposited along a substantial portion of the wiper 339. By having an elongated nozzle 513 that can eject foam along a substantial portion of the wiper 539, this problem is alleviated.

An additional feature of the wiper 539 is that when very low pressure is used, the wiper 539 can retain the foam more readily on the surface of the tube 565. With very low pressure, e.g., 0.5 to 5 psi, the foam can gather on the tube 565 without being ejected away from it. Testing has shown that even if the nozzle 513 is pointed downward as shown in FIG. 5C, the foam 533 can cling to the surface of the tube 565.

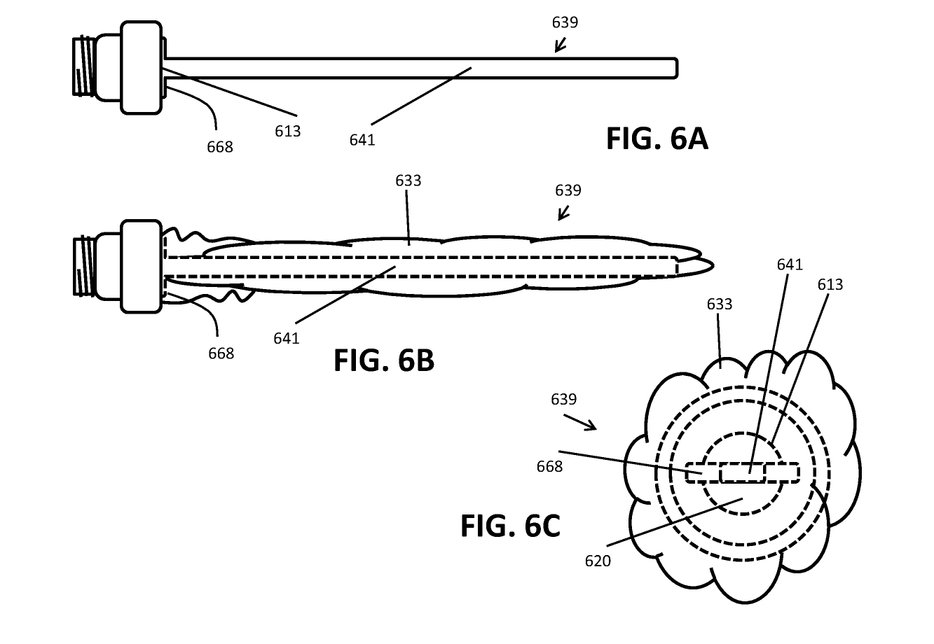

FIGS. 6A to 6C show another example of a wiper 639. It can resemble the examples given above with differences. In this example, the wiper 639 can consist of one elongated member 641 to which foam 633 can attach. The member 641 can attach to the distal end of the mixing chamber 322 (as shown in FIG. 3A) with a span 668 across the nozzle 613. The foam 633 can flow out of the nozzle 613 and encase nearly all sides of the member 641. The member 641 can be made of elastic material such as plastics or spring steel with memory that would prevent drooping but allow the member to function like a spatula. For most uses, the elongated member 641 can preferably be a rectangular piece about 0.5 to 4 cm in width, about 0.5 mm to 2 mm in height and can preferably have a length of about 3 to 15 cm.

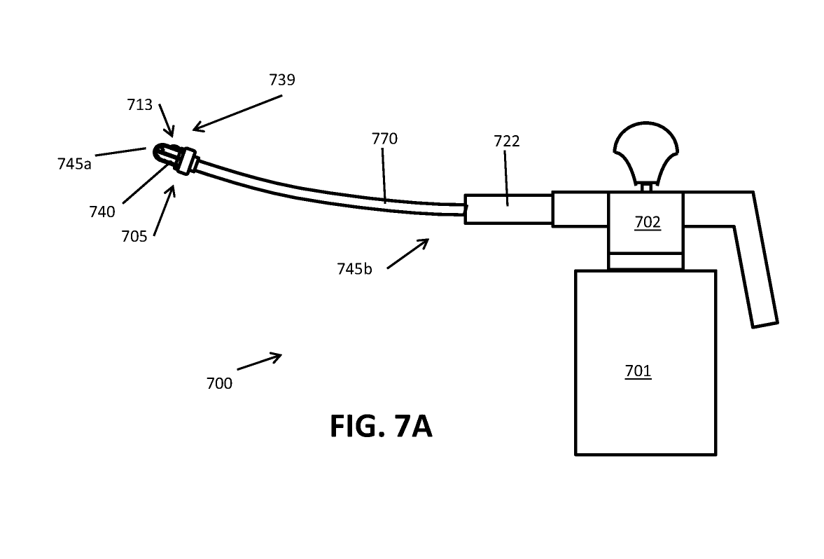

FIG. 7A shows another example of dispenser 700 with an outlet assembly 705. It can resemble the examples given above with differences. In this example, the wiper 739 is attached to a medium sized handheld dispenser 700. The dispenser 700 can also have a pressurized tank 701 that generally pressurizes like dispenser 100. The tank 701 can be smaller—perhaps 0.5 to 5 liters for most uses and have a smaller pump head 792. The wiper 739 can have a cage 740 similar to cage 440—previously discussed. The nozzle 713 and wiper 739 can be at the distal end 745a of an extension tube 770 and the wiper 739 can be some distance—perhaps 20 to 35 cm in this example—distal to the mixing chamber 722. Thus, the foam (not shown) will travel some distance in the extension tube 770 before being expelled from the nozzle 713.

This dispenser 700 can be used for many kinds of applications, especially smaller jobs. One advantage of this dispenser 700: If the dispenser 700 is used and foam remains in the extension tube 770, that foam will eventually drain and liquid will form in the tube 770. This would normally create a dripping problem. The extension tube 770, however, can be positioned with its curvature pointing upward. Although the extension tube 770 can flex, it can have a memory and return to this position. The advantage of the upward curvature is that when the dispenser 700 is put down in an upright position shown in FIG. 7A, any liquid that forms can trickle back toward the proximate end 745b of the extension tube 770, thereby minimizing dripping.

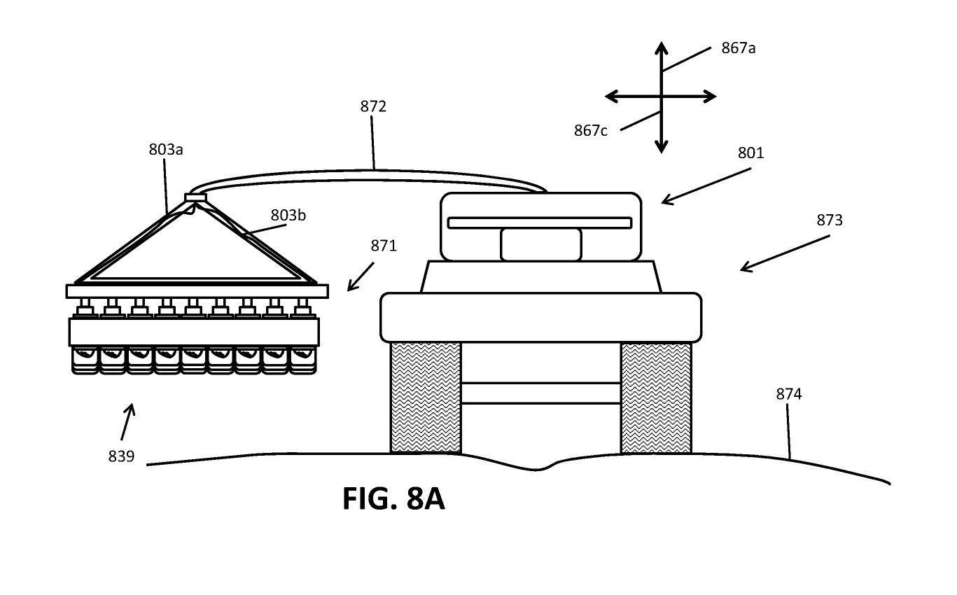

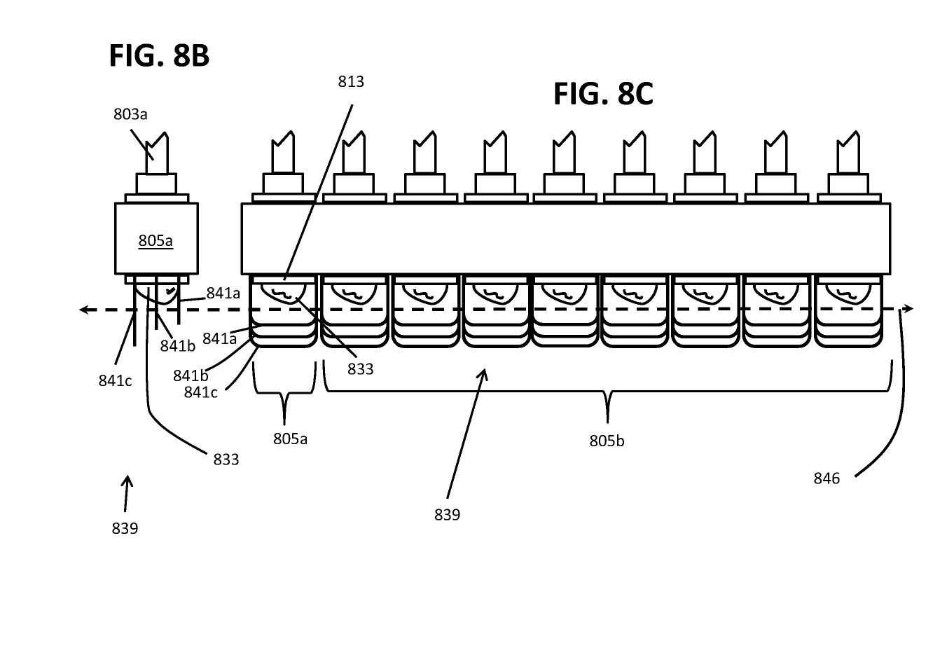

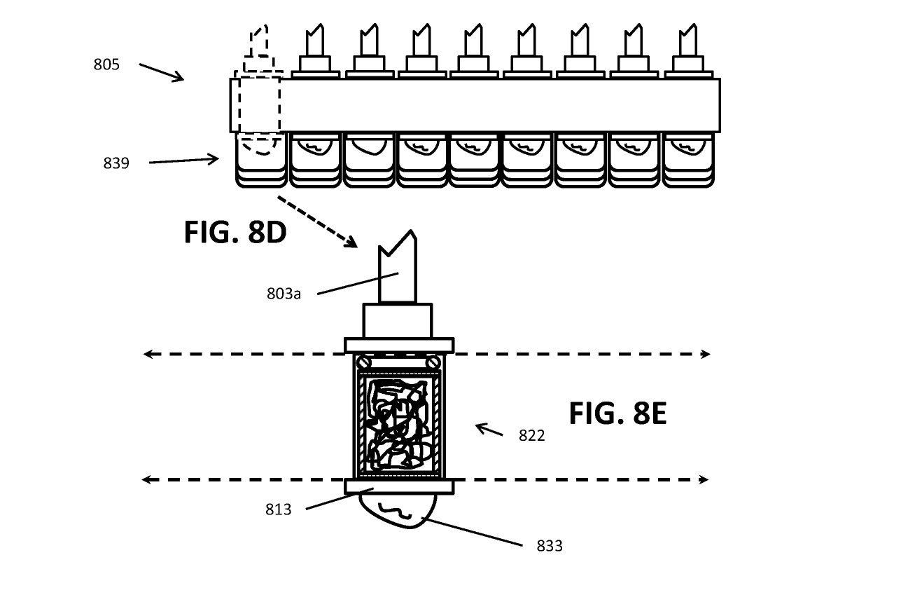

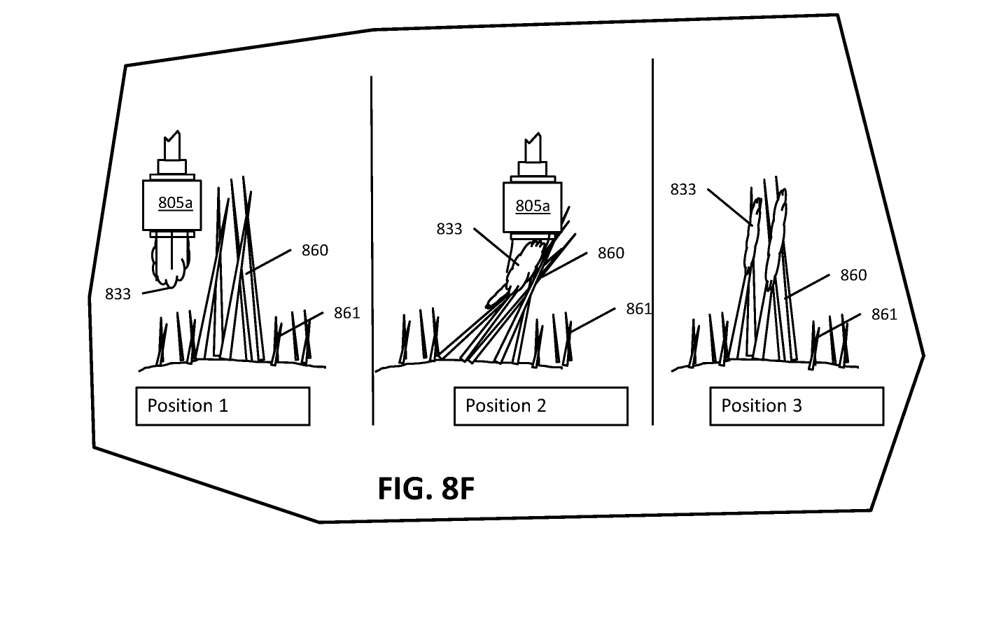

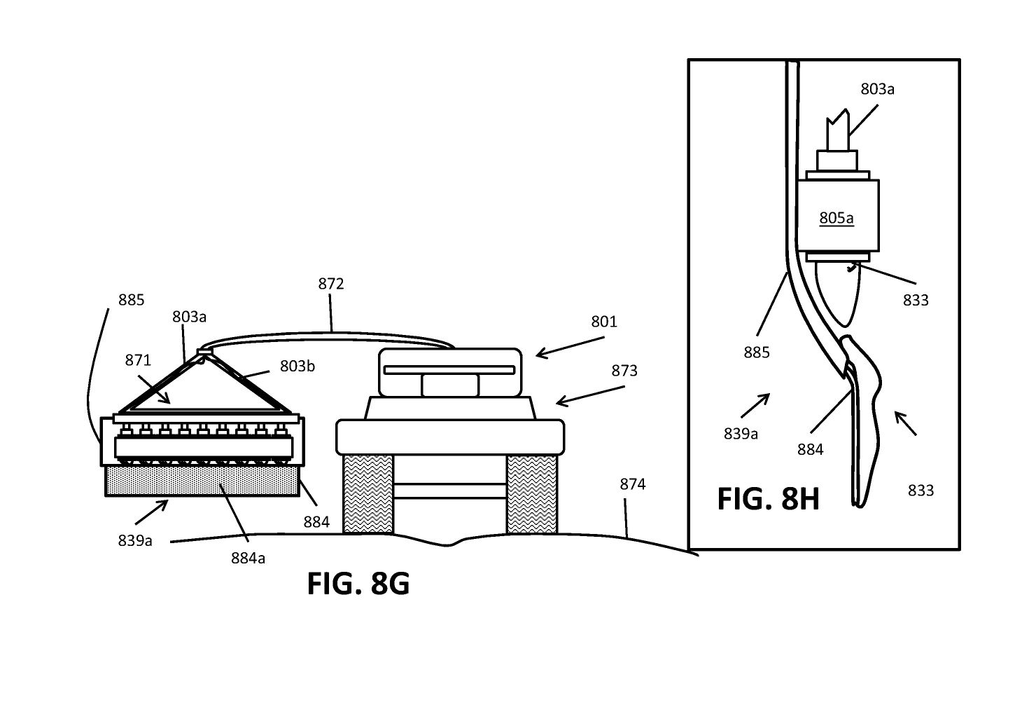

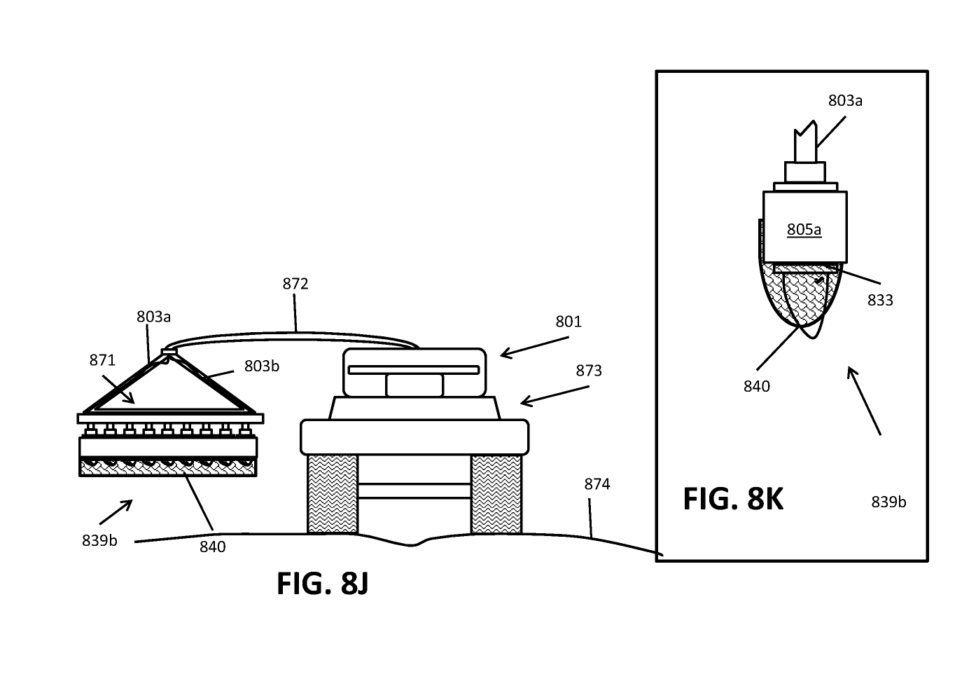

FIGS. 8A to 8F show another example of a dispenser with a wiper 839. It can resemble the examples given above with differences. In this example, the wiper 839 can be attached to a boom 871. The boom 871 can in turn be attached to a boom pole 872. The boom pole 872 can be attached to a vehicle 873 such as a tractor, trailer, watercraft, aircraft (such as a helicopter), or, as shown in FIG. 5A, an ATV. The vehicle 873 shown in FIG. 8A is facing forward. The vehicle and others like it can be driven in various ways, e.g., by a human, by remote control, or by computer (i.e., be a robot).

The wiper 839 could be used in fields, in pastures, and for other larger herbicide application jobs. When a pasture is grazed, for example, weeds are often ignored by the livestock because they are unpalatable and thus grow taller than the forage crop. The wiper 839 could be pulled across tall weeds. In other instances, weeds can be spot treated with the wiper 839 or, if weeds dominate an area, the entire area can be treated.

The position of the boom pole 872 could be preferably be adjustable by an operator (not shown). This could allow, for example, the boom 871 to be raised upward 867a or lowered 867c so that weeds of different heights could be targeted. Motors, hydraulics, manually operated mechanisms, etc. (not shown), could be used to adjust and fix the boom 871 position. Preferably the height of the boom 871 can be adjusted in such a way that the longitudinal axis 846 of the boom 871 and wiper 839 stays generally parallel to the ground 874, i.e., positioned horizontally.

The boom 871 can have foam ejection system for ejecting foam 833 along the length of the boom 871 onto a series of wiping members such as 841a, 841b, 841c. In this example, the system can comprise a series of outlet assemblies The first outlet assembly 805a can be supplied with fluid through a unit hose 803a. (805b represents the nine additional outlet assemblies, all of which can resemble the first outlet assembly 805a.) A mixing chamber 822 can condition the foamable liquid into a foam 833 and the foam can be ejected from a nozzle 813. The group of three wiping members 841a, 841b, 841c can be located below nozzle 813. FIG. 8B shows a side view and 8C a front view of the first wiping unit 805a. The wiping members 841a, 841b, 841c can be flexible, for instance they may be made of spring steel wire for lighter weed infestations. The remaining units 805b can operate similarly to unit 805a.

The outlet assemblies 805a and 805b can be configured to eject foam at even rates, thereby ensuring that all parts of the wiper 839 are supplied with equal amounts of foam. However, the system could also allow flow to individual outlet assemblies 805a, 805b to be increased if one portion of the wiper was wiped clean due to heavy weed infestations.

FIG. 8F shows a side view of how the wiper 339 might be used to apply foam to target weeds. The sequence from Position 1 to Position 3 shows a side view of the first outlet assembly 805a and how it can be positioned to be dragged across target foliage 860. Position 1 shows foam 833 loaded onto the wiping members 841a, 841b, 841c. Position 2 shows the wiping unit 839a contacting the target foliage 860. The wiping members 841a, 841b, 841c can have sufficient elasticity that they bend when contacting the foliage 860. The contact has transferred some foam 833 to the target foliage 860. Position 3 shows completion of the task with the target foliage 860 having returned to its upright position with foam 860 on the target foliage 860.

The wiper 839 can be designed to have a length suitable for the intended tasks and for the vehicle on which it is mounted. A shorter wiper (approximately 25 cm to 1.5 m might mount to a hand-pulled cart or small robot (not shown), a slightly longer one to an ATV or small tractor (approximately 50 cm to 4 m), and an even longer one (approximately 2 m to 10 m or more) to a large trailer, tractor, or spray rig for field use (not shown). For a larger wiper (not shown), multiple supply lines supplying foam to multiple sections of a wiper may be desirable. For an even larger device, having multiple wipers mounted on a folding boom (not shown) may be preferable.

FIGS. 8G and 8H show a variation on the example shown in FIGS. 8A to 8F. The main difference can be in the wiper 839a. The wiper 839a can comprise an elongated mat 884 held in place by a bracket 885 attached to the boom 871. The wiper 839a can be suspended beneath the nozzles such as the first nozzle 813. When foam 833 is ejected from the nozzles, it can fall onto the wiper 839a, primarily on the mat face 884a (the front face of the mat 884). It may also fall on portions of the bracket 885.

The bracket 885 can be made of a relatively stiff material such as metal or hard plastic. The mat 884 can be a substantially two-dimensional piece having more flexibility. The mat 884 might for example be made of a rubberized material that flexes (having for example the flexibility of a typical rubber doormat.) The mat 884 is preferably impervious and non-absorbent. Thus, most of the foam 833 would remain on the mat face 884a and this would be beneficial since the vehicle's primary direction of movement would be forward. Thus, the bulk of the foam 833 would be available for being wiped onto target plants (not shown) while the vehicle 873 moves forward.

In another example (not shown) the bracket 885 and mat 884 could be removed. This would allow the nozzles to drizzle or spray foam without a wiper 839a. This might be suitable when the entire path the boom 871 takes needs to be treated. For example, if a lawn were being fertilized with a foam fertilizer, this might be a useful configuration because it would eject foam evenly along a substantial portion or most of the length of the boom 871.

FIGS. 8J and 8K show a variation on the example shown in FIGS. 8A to 8H. The main difference can be in the wiper 839b. The wiper 839b can comprise a cage 840, resembling in this example an elongated, mesh bag. The cage 840 can fasten to the boom 871. The cage 840 can catch the foam 833 ejected from the nozzles such as the first nozzle 813 as shown in FIG. 8K. When the cage 840 is filled with foam, it can be dragged across target plants 860.

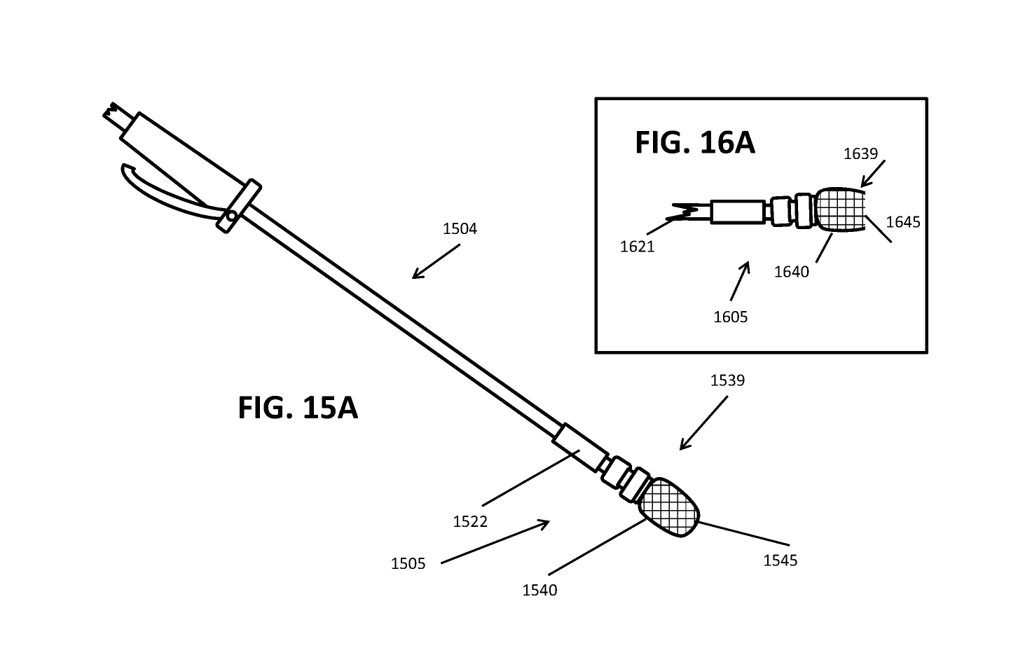

The cage 840 can be made of various materials. A plastic mesh similar to the mesh discussed below, for example, in relation to wiper 1539 and FIG. 15A may be suitable. A heavier duty mesh may be preferable, however, for more industrial-scale work. McMaster-Carr offers a product, non-elastic polyethylene mesh sleeve for 1¾ in. diameter, gray, Product No. 5979K86. This is a heavier duty mesh that would be less likely to stretch or tear. Many other types of perforated products including metal mesh in the form of chain mail may also be suitable. FIGS. J and K show the cage 840 having a closed-off end. However, this would not be necessary. The container 840 could have open-ends, so long as the open-ends extended far enough so that foam would not easily escape out the open-ends (not shown).

The example shown in FIGS. 8J and 8K can offer several advantages: it would be economical to manufacture; the cage 840 could preserve the foam without drippage; and the cage 840 could conform somewhat to the shape of the plants being wiped. This could maximize the amount of foam 833 transferred. Moreover, the cage 840 can provide even support for the foam making it less likely to drip.

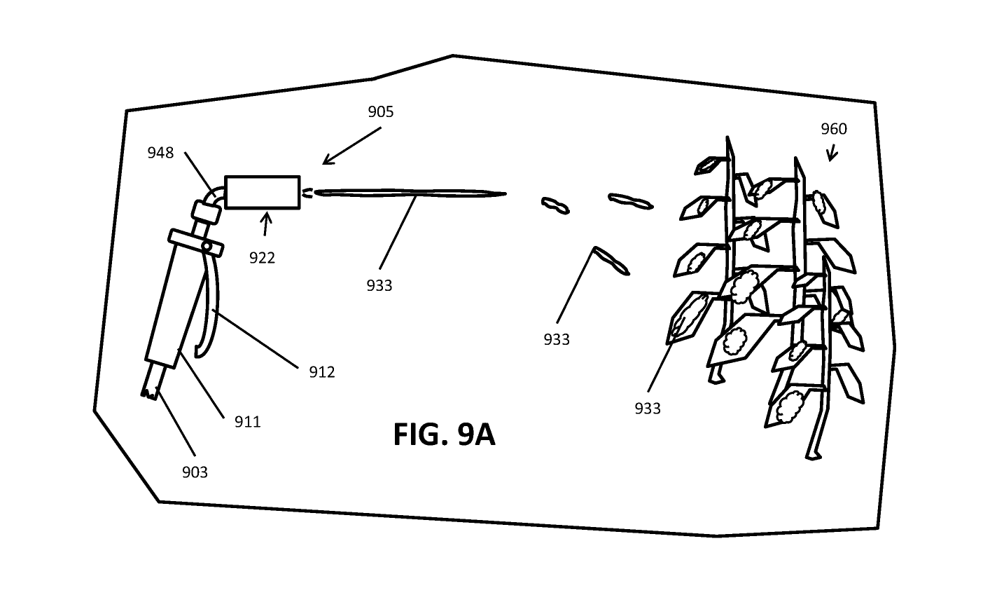

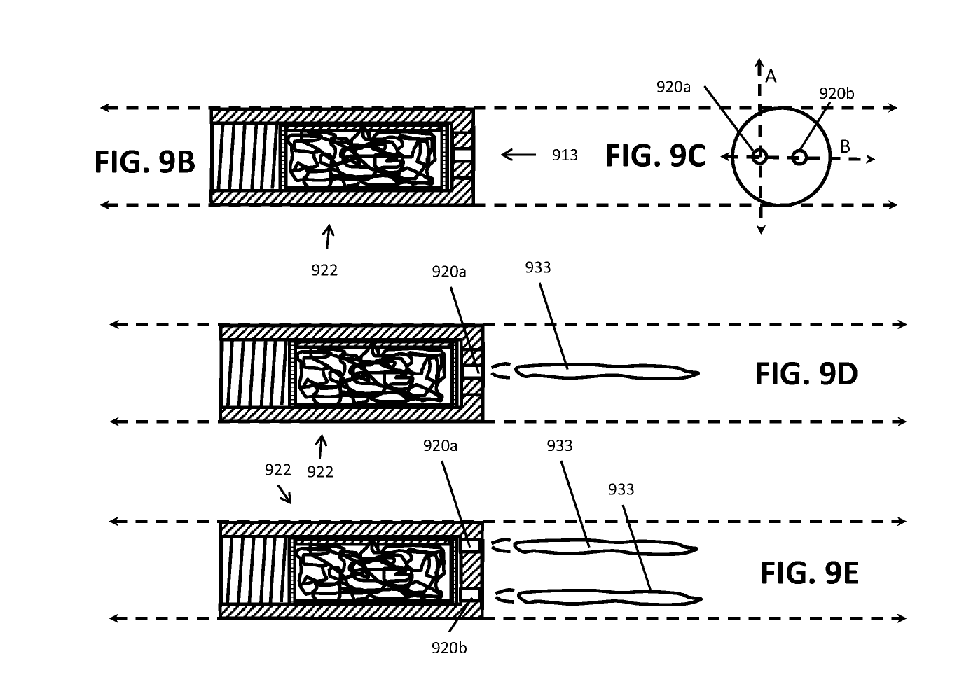

FIGS. 9A to 9E show another example of the dispenser outlet assembly 905. This outlet assembly 905 can resemble those discussed above in some ways but differ in other ways. The dispenser can employ the same pressurized tank 101, pump head 102, and handle 111 discussed in the above examples. However, the wand tube 121 can be eliminated. An elbow connector 948 can allow the outlet assembly 905 to be positioned at a generally horizontal position when held straight out by the operator's hand (not shown).

The mixing chamber 922 can be configured almost identically to the mixing chamber 122 discussed in the above examples. However, the nozzle 913, instead of a single large orifice 120, can have one or more orifices. In this example, the nozzle 913 has two orifices, 920a, 920b. The orifices 920a, 920b can be approximately 2 mm in diameter and approximately 1 to 2 cm apart and can produce two streams of foam 933. In using a prototype with an outlet assembly similar to outlet assembly 905, it was found that relatively low pressures below 15 psi could create streams of foam 933 that could project approximately 1 to 4 meters. Moreover, the foam 933 could be dispensed with minimal creation of fine drops that have the potential to drift.

The streams of foam 933 created by the outlet assembly 905 shown in FIGS. 9A to 9E can be especially suitable for low/volume high concentration herbicide applications. In these applications a more highly concentrated herbicide mixture is used, a bigger mass of the herbicide mixture is deposited on any one leaf, and less foliage of the target plant 960 overall is covered—sometimes as little as 10 to 30% of the target weed 960 need be covered for an effective treatment.

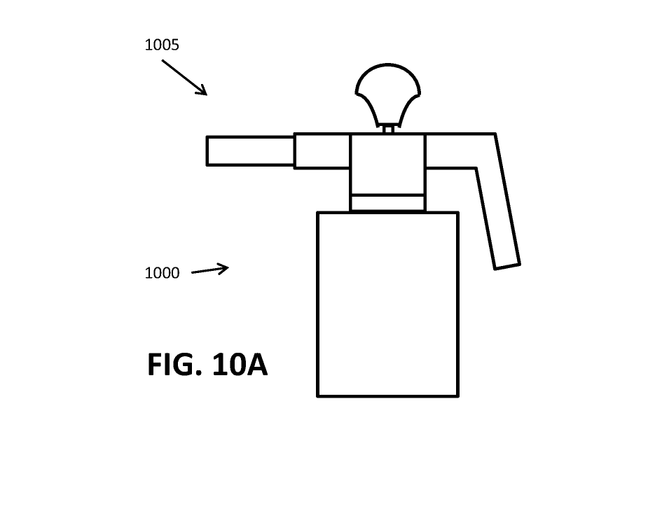

FIG. 10A shows another example of the dispenser outlet assembly 1005. The dispenser outlet assembly 1005 can be identical to the one shown in FIGS. 9A to 9E. It can likewise eject streams of foam (in this case two) and be especially useful for foliar applications. The dispenser 1000 can resemble the one shown in FIG. 7A. This version of the dispenser 1000 can be highly portable.

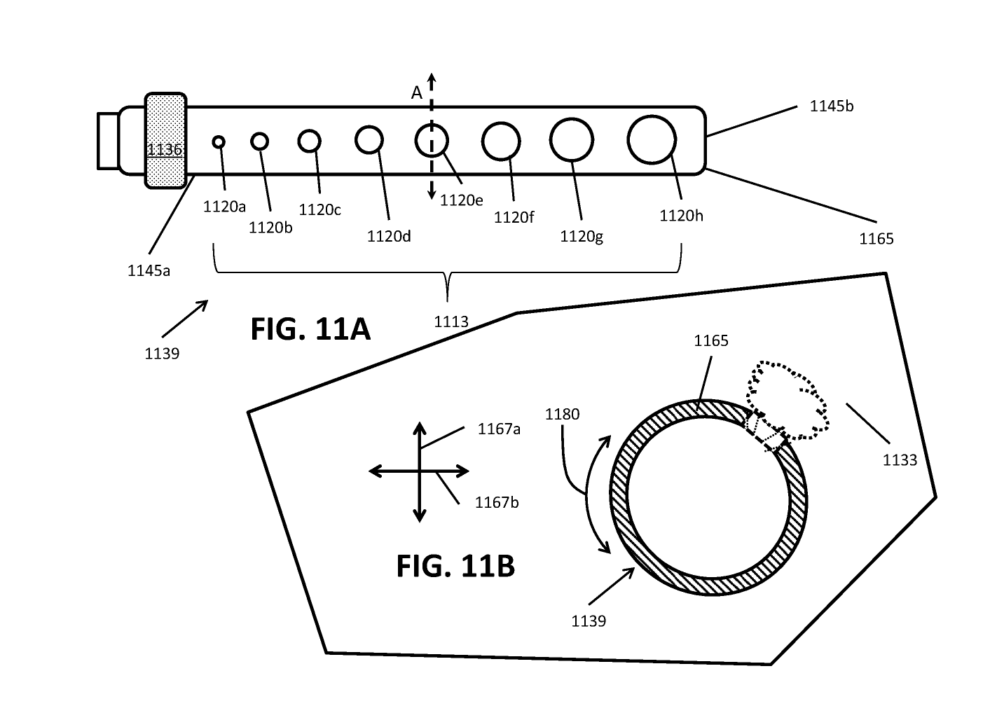

FIGS. 11A and 11B show another example of a wiper 1139. It can resemble the examples given above (especially wiper 539 associated with FIGS. 5A to 5C) with differences.

The wiper 1139 can have a hollow elongated tube 1165 with a closed distal end 1145. Foam 1133 can fill the tube 1165 and be released onto the wiping surface (which can be the entire exterior surface of the tube 1165) from a series of holes identified as 1120a to 1120h in the wall of the tube 1165. (The entire series of holes, 1120a to 1120h can be considered an elongated nozzle 1113.) The holes 1120a to 1120h can get larger towards the distal end 1145 where pressure can be lower inside the tube 1165. This can help equalize the amount of foam released through the holes 1120a to 1120h on the proximal 1106a and distal ends 1106b of the tube 1165. The tube 1165 can be rotated 1180 and locked in place with a lock nut 1136.

The wiper 1139 can also be used to drizzle or spray foam onto target foliage, depending how much pressure is used. To drizzle foam onto target plants (not shown), the assembly 1105 can be held some distance from the target foliage—in most cases, somewhere between a few centimeters and a meter (at least for a device held in the hand). Moderately low pressure, between, e.g., 5 and 10 psi might be used. Such moderate pressure can prevent foam from bunching up on the wiper 1139. Drizzling foam from the assembly 1105 can be a very useful way to rapidly apply foam herbicide to target foliage. Drift can be greatly minimized even in windy conditions because the thick streams of foam ejected from the outlet assembly 1105 are heavy and are ejected under low pressure. In addition, for more precision—near a desirable plant for instance—the foam can be wiped onto the leaves of the target weed under low pressure, e.g., from 0.5 to 5 psi. This makes this wiper 1139 highly versatile.

An additional feature of the wiper 1139 is that the tube 1165 can be rotated 1180 into different positions. A lock nut 1136 can lock the tube 1165 into the desired position. This can, for example, allow the nozzle 1113 to point in a forward 1167b, upward 1167a direction as shown in FIG. 11B. This position can be beneficial because gravity can help the foam stay on the surface of the tube 1165. Having the nozzle 1113 point forward can encourage the foam to collect on the forward side which can be used to wipe against target plants (not shown).

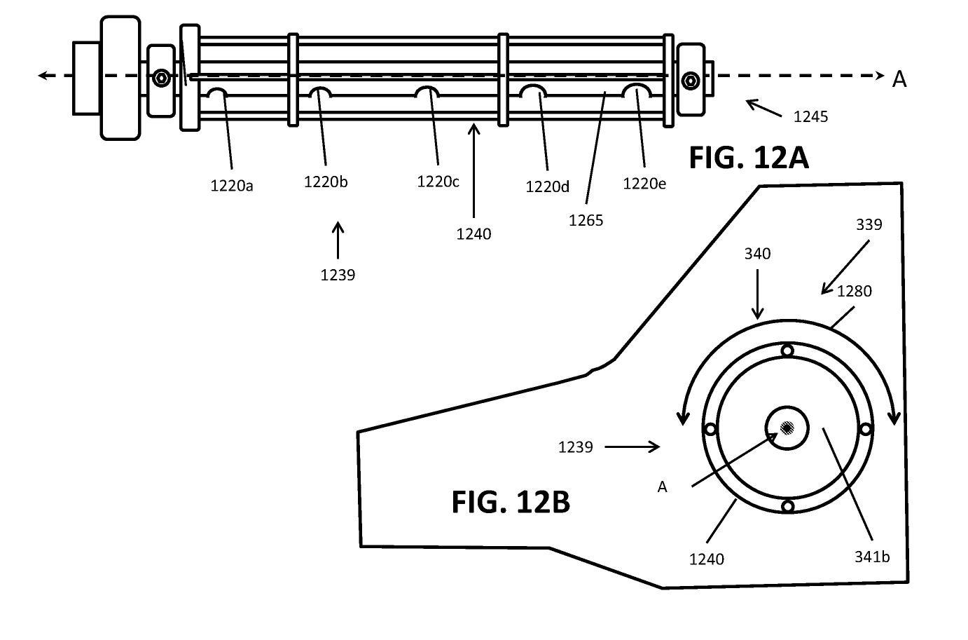

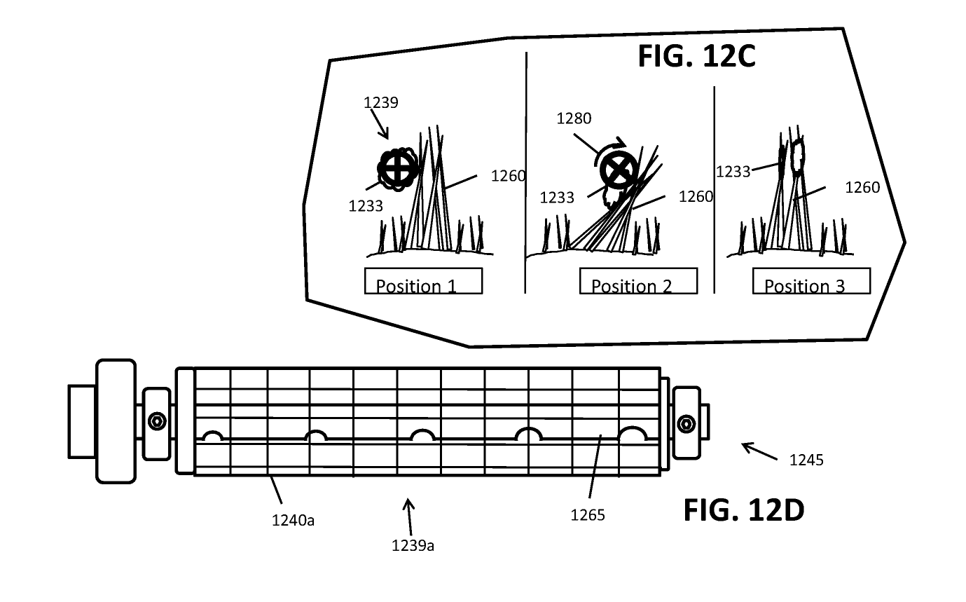

FIGS. 12A to 12C show another example of a wiper 1239. It can resemble the examples given above with differences. The wiper 1239 can include a hollow elongated tube 1265 with a closed distal end 1245. Foam 1233 can fill the tube 1265 and be released through a series of holes 1220a to 1220e from the tube 1265. The holes 1220a to 1220e can resemble those shown in FIGS. 11A and 11B; however, in this example there are only five holes, 1220a to 1220e. The tube 1265 can also be enclosed in a cage 1240. The cage 1240 shown in FIGS. 12A to 12C can also rotate 1280 freely around the tube 1265. FIG. 12C, shows the rotating cage 1240 being used to apply foam herbicide to grass 1260. As in Position 1, the rotating cage 1240 can be brought into contact with the target grass 1260. Then, as rotating cage 1240 is dragged over the grass 1260, the cage 1240 can rotate as shown in Position 2. Position 3 shows the foam herbicide 1233 deposited on the target grass 1260.

The cage 1240 shown in FIGS. 12A to 12C shows one that has large openings and fairly stout cage members similar to those shown in FIGS. 3A to 3F. However, the cage can also be made of a metal or plastic mesh. FIG. 12D shows a wiper 1239a with a slightly different cage 1240a, one made of mesh. Such a mesh material could be of various materials such as plastic or metal and would preferably be more flexible than cage 1240 but stiffer than the mesh used for the cages 1540, 1640, and 1740 discussed below. The cage 1239a could have fairly wide openings—e.g., square openings approximately 20 by 20 mm might be suitable. The dimensions of the cage might be approximately 4 cm diameter by approximately 15 cm.

The advantages these wipers 1239 and 1239a can be several. First, unlike wiper 339 shown in relation to FIGS. 3A to 3F, foam 1233 can be ejected along a substantial portion of the interior of the wipers 1239, 1239a. This can prevent, as discussed earlier, a plug of foam forming inside the cage 1240, 1240a and blocking even-filling of the cage. Moreover, because the cages 1240, 1240a can rotate freely, foam 1233 is less likely to collect in a portion of the cage 1240, 1240a not in contact with plant surfaces. In addition, the rotating cages 1240, 1240a can help ensure that more equal amounts of foam 1233 are deposited on target plants 1260.

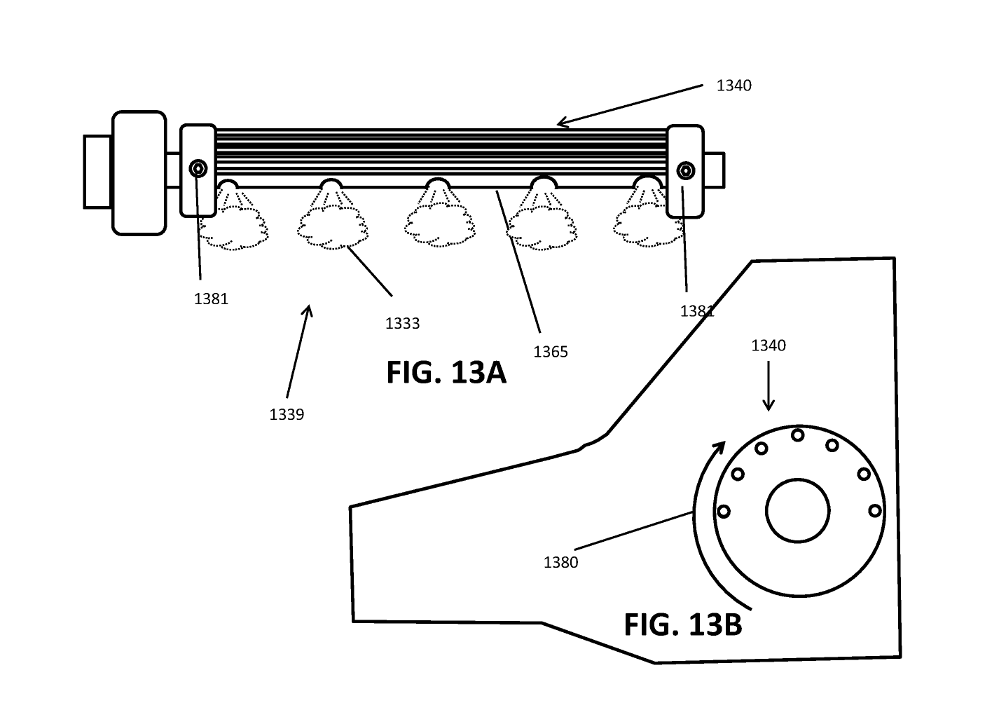

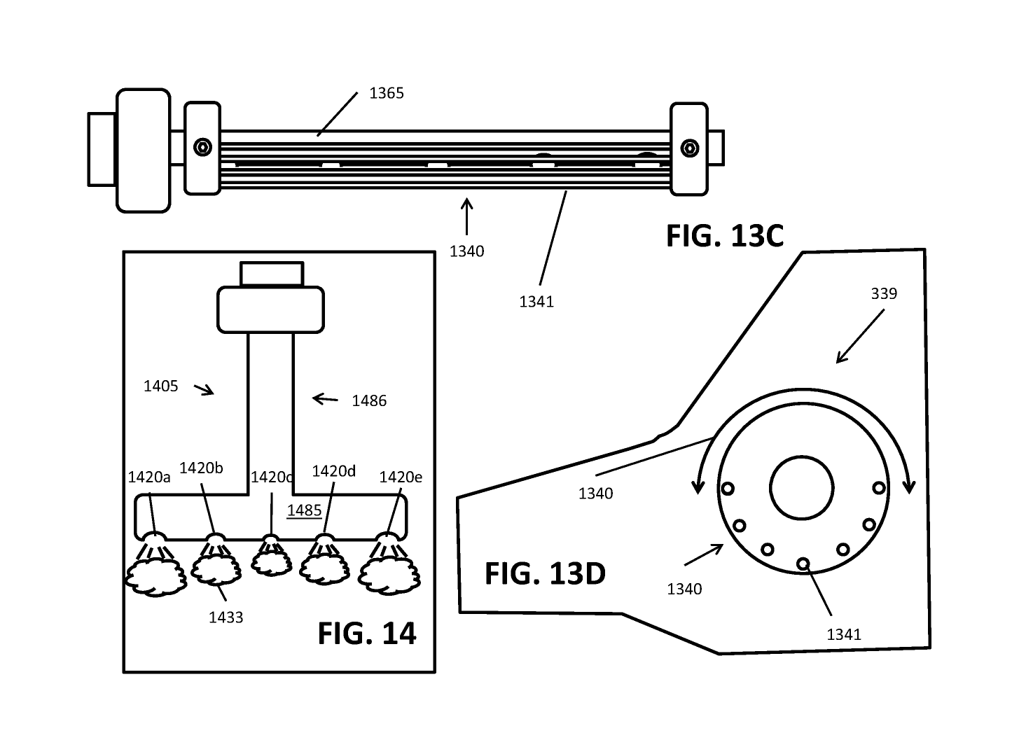

FIGS. 13A to 13D show another example of a wiper 1339. It can resemble the examples given above with differences. The wiper 1339 can include a hollow tube 1365 similar to the one discussed in relation to FIGS. 12A to 12C. The tube 1365 can be enclosed in a partial cage 1340. The partial cage 1340 can rotate 1380 around the tube 1365. The partial cage 1340 can be positioned in the desired position and then locked into that position with set screws 1381. For example, in FIGS. 13A and 13B the partial cage 1340 is locked in a position that allows foam 1333 to be expelled from the tube 1365 without the cage members 1341 obstructing the passage of the foam.

Alternatively the partial cage 1340 can be rotated 1380 to the position shown in FIGS. 13C and 13D. In this position, the partial cage 1340 could obstruct foam (not shown) ejected from the tube 1365. The wiper 1339 could then be used to wipe foam 1333 from the cage 1340 onto target foliage.

Advantages of the partial cage 1340 shown in FIGS. 13A to 13D could include its versatility. It can allow the assembly 1305 to be used as a wiper or device from which foam herbicide could be sprayed or drizzled.

FIG. 14 shows an example of a portion of a dispenser outlet assembly 1405. In this example the assembly 1405 is t-shaped and can have a round, tubular structure. The distal tube 1485 can have holes 1420a to 1420e in it. In this example, the assembly has 5 holes 1420a to 1420e from which foam 1433 can be ejected. The middle hole 1420c can be the smallest and the two distal holes 1420a and 1420e the largest and of the same size to equalize pressure across the face of the distal tube 1485. A supply tube 1486 can connect the assembly 1405 to a wand or other attachment (not shown). This assembly 1405 can be used much like the assembly 1105 shown in relation to FIGS. 11A and 11B. This outlet assembly 1405 can be used for foliar spraying for example.

FIG. 15A shows the best mode, a wand 1504 with an outlet assembly 1505 resembling the outlet assembly shown in FIG. 4A, having a mixing chamber 1522 and a wiper 1539. It has some differences. The wiper 1539 can be a cage 1540 in the form of a mesh bag. The mesh bag can be made of a plastic mesh similar to that used for mesh produce bags, i.e., the bag can be very flexible and the structure stretchy. The mesh of the cage 1540 can close off the distal end 1545.

The wiper 1539 can be very useful for spot treatments. Manufacturing of the wiper 1539 can be economical. In addition, the flexibility of the cage 1540 can allow it to be smashed against surfaces (not shown) in order to expel most of the foam from the cage 1540. Foam can easily be expelled from the structure because the gauge of the mesh is so thin.

FIG. 16A shows a portion of a wand 1621 with an outlet assembly 1605 resembling the outlet assembly shown in FIG. 15A. It has some differences. The wiper 1639 can be a cage 1640 in the form of a mesh tube with an open distal end 1645 of the cage 1640. An advantage of this cage 1640 is that foam can flow even more freely into the tube because the open end 1645 of the cage creates no obstruction. And, the open end 1645 can allow foam (not shown) to be moved more freely out the distal end 1645 of the cage 1640.

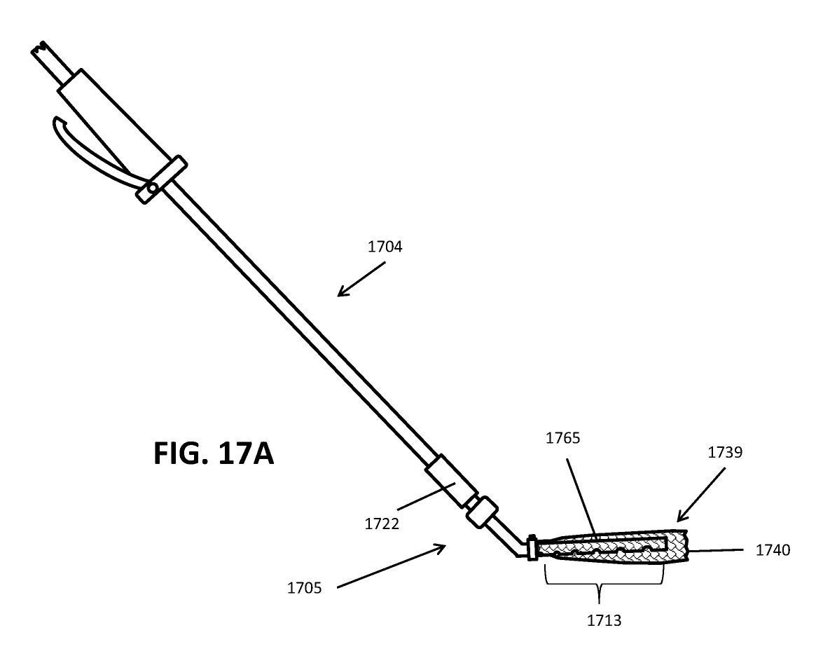

FIG. 17A shows a wand 1704 with an outlet assembly 1705 including a mixing chamber 1722 and a wiper 1739. The wiper 1739 comprises a tube 1765 with a nozzle 1713 consisting of six holes. The wand 1704 and tube 1765 resemble many of the examples previously discussed such as the wand 404 discussed in relation to FIG. 4A and the wiper 1139 discussed in relation to FIGS. 11A and 11B. However, the wiper 1739 can also include a cage in the form of a mesh tube 1740.

The mesh tube 1740 can cover most of the tube 1765. Preferably it covers all the tube since foam released from the nozzle should preferably remain in the cage 1740. The cage 1740 can be open on the end. When foam is ejected (not shown) from the nozzle 1713, it can fill the cage 1740. This cage 1740 is preferably made of very flexible and stretchy material such as light gauge plastic mesh (similar to that used for produce bags).

Other embodiments (not shown) could be configured differently than as described above. Various components of one embodiment could be integrated into another. The dispenser systems could be powered for example with electricity or gas. The dispenser systems could be robotic and operated by a computer. Many of the dispensers shown have a tubular structure. The tubes need not be round; they can be different shapes including square, rectangular, oblong, etc.

While the above-discussed embodiments of the present invention generally relate to foam herbicide, a foamable pesticide dispenser and associated methods of using a dispenser to apply foamed solutions such as pesticide formulations to plants, the invention is not so limited. The dispenser, for example, may be useful for other purposes, such as the application of foamable growth stimulants, nutrients or other chemicals. It may be useful for applying mixtures to objects other than plants. For example, it may be useful for applying cleaners, disinfectants, preservatives, treatments, etc., to food preparation surfaces, windows, walls, etc. The invention should be understood to encompass these other uses although such other uses may not be discussed below.

The invention has been described with reference to various and specific non-limiting embodiments, examples and techniques. It will be understood by one of ordinary skill in the art, however, that reasonable variations and modifications may be made with respect to such embodiments and techniques without substantial departure from either the spirit or scope of the invention defined by the following claims. For example, while suitable sizes and parameters, materials, packaging and the like have been disclosed in the above discussion, it should be appreciated that these are provided by way of example and not of limitation as a number of other sizes and parameters, materials.

What is claimed:

1. A dispenser for dispensing a foam, comprising:
a supply line in which a foamable solution flows under pressure and which comprises a gas inlet, a wand, a mixing chamber, and a nozzle,
wherein the gas inlet introduces a gas into the foamable solution, the mixing chamber helps process the foamable solution into a foam, and the nozzle ejects the foam.

2. The dispenser of claim 1, where the gas is introduced proximally to the mixing chamber in the supply line.

3. The dispenser of claim 1, wherein the mixing chamber is located distally on the wand.

4. The dispenser of claim 1, wherein the mixing chamber contains a mixing medium.

5. The dispenser of claim 1, wherein the supply line further comprises a hose proximate to the wand.

6. A pressurized dispenser for dispensing a foam, comprising:
a wand fluidly connected to a nozzle for ejecting a foam and a wiper attached to the wand, the wiper being for temporarily retaining ejected foam and making the foam available for wiping the foam onto a target surface.

7. The dispenser of claim 6, wherein the wiper is a cage.

8. The dispenser of claim 6, wherein the wiper is a cage, the cage being tubular with at least one open end.

9. The dispenser of claim 6, wherein the wiper is a cage, the cage being tubular with no open end.

10. The dispenser of claim 6, wherein the wiper is a cage, the cage being a mesh material.

11. The dispenser of claim 6, wherein the wiper is a cage being rotatable on a longitudinal axis.

12. A dispenser for dispensing a foam comprising: an elongated tube and a nozzle in the wall of the tube for ejecting foam from the tube.

13. The dispenser of claim 12, wherein the nozzle is in a discrete portion of the wall of the tube.

14. The dispenser of claim 12, wherein the nozzle is elongated.

15. The dispenser of claim 12, wherein the tube has a firm wall.

16. The dispenser of claim 12, wherein the nozzle ejects foam along most of the length of the tube.

17. The dispenser of claim 12, wherein the tube comprises two longitudinal halves and wherein the discrete portion is located in one of those halves.

18. The dispenser of claim 12, wherein the dispenser further comprises a wiper attached to the dispenser, and the nozzle ejects foam onto a surface of the wiper.

19. The dispenser of claim 12, wherein the dispenser further comprises a wiper attached to the dispenser, and the nozzle ejects foam onto a surface of the wiper and where the wiper further comprises a cage.

20. The dispenser of claim 12, wherein the dispenser further comprises a wiper attached to the dispenser and the nozzle dispenses foam onto a surface of the wiper and where the wiper further comprises a rotatable cage.
